(19) United States
(12) Patent Application Publication
(10) Pub. No.: US 2006/0011480 A1
(43) Pub. Date: Jan. 19, 2006

(54) Separation apparatus, method of fabricating the same, and analytical system

(76) Inventors: Toru Sano, Tokyo (JP); Masakazu Baba, Tokyo (JP); Kazuhiro Iida, Tokyo (JP); Hisao Kawaura, Tokyo (JP); Noriyuki Iguchi, Tokyo (JP); Toshitsugu Sakamoto, Tokyo (JP); Wataru Hattori, Tokyo (JP); Hiroko Someya, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/532,978

(22) PCT Filed: Oct. 29, 2003
(86) PCT No.: PCT/JP03/13852

§ 371 Date: Apr. 28, 2005

(30) Foreign Application Priority Data
Oct. 30, 2002 (JP) 2002-316872
Oct. 24, 2003 (JP) 2003-365142

(51) Int. Cl. C02F 11/00; G01N 27/27

(52) U.S. Cl. 204/601; 204/451; 29/592.1

(57) ABSTRACT

A separation apparatus (100) has a separation channel (112), a partition wall (301a) and a partition wall (301b), wherein each of the partition wall (301a) and the partition wall (301b) has a capture portion (300) formed thereon. Molecules having a size acceptable by the capture portions (300) provided on the partition wall (301a) and the partition wall (301b) are captured by the capture portion (300) and reduced in the travel speed through the separation channel (112), and this makes it possible to precisely separate the sample depending on the molecular size.

### BACKGROUND OF THE INVENTION

1. Field of the Invention

The present invention relates to an apparatus and a method of separating samples, and more particularly to an apparatus and a separation method preferably applicable to fine-scale separation of substances including nucleic acid fragments of various sizes, such as cell and nucleic acid fragment; organic molecules such as amino acid, peptide and protein; metal ion, colloid and latex bead.

2. Description of the Related Art

Analyses of biological substances such as cell, nucleic acid and protein need preliminarily separation and purification of samples, or preliminarily isolation based on their sizes and electric charges. For example, the dideoxy method (Sanger method) is widely used for determining base sequence of DNA. In the process of synthesizing a complementary DNA by the Sanger method using a target single-strand DNA as a template, Taq polymerase and four kinds of deoxyribonucleotides, a single kind out of four dideoxyribonucleotides is added to inhibit the DNA synthesis, to thereby synthesize fragments having various lengths. The reaction is repeated for each of four above-described species, the fragment is then loaded and separated on a polyacrylamide electrophoretic device having a resolution power of a single base, to thereby clarify the DNA sequence. This sort of separation operation holds the key for determining time consumed for the analysis, and reduction in the time consumption for the separation is understood as an important technical problem in this field. For this purpose, there is a demand for developing a separation apparatus having a satisfactorily high level of resolution, and being capable of accurately separating a desired substance within a short time.

The separation apparatus which have conventionally been used include ultracentrifugal separation apparatus and capillary separation apparatus. The ultracentrifugal separation apparatus and capillary separation apparatus, however, take a long time for the separation, and need a large amount of samples. The resolution does not always reach a satisfactory level.

On the other hand, U.S. Pat. No. 6,027,623 discloses an apparatus of separating a target substance, having a large number of obstacles arranged in a matrix pattern so as to allow separation of DNA molecules by their length. In this apparatus, a plurality of fluid channels bounded by a plurality of obstacle columns, and a plurality of fluid passageways bounded by a plurality of obstacle rows are formed. When applied with an electric field, molecules flow through the fluid channel between the obstacle lines, but are pushed back by the back wall portion of the obstacles, and are allowed to diffuse into a plurality of portions between the fluid channels. Because diffusion rate of molecules depends on their molecular sizes and other physical characteristics, this makes it possible to separate different molecules. In this case, a smaller molecule will diffuse faster and take a longer time to diffuse in the fluid channel.

### SUMMARY OF THE INVENTION

It has, however, been difficult for this technique to precisely fabricate such a large number of obstacles while ensuring small gaps therebetween, so that it has consequently been difficult to fully reduce the gaps between the obstacles. It has also been known that the configuration, in which a large number of fine obstacles are arranged in a matrix pattern, raises another problem in that the obstacles are likely to be damaged in the formation process or during use of the separation apparatus. It is also to be noted that the separation of the molecules herein is based on difference in the diffusion rate, but a more precise separation of a sample containing molecules of various sizes needs further examination, because the diffusion rate of molecule depends not only on molecular size but also on various physical properties.

The present invention was conceived after considering the above-described situation, and an object thereof resides in providing a separation technique capable of separating a sample containing substances of various sizes with an excellent resolution. It is another object of the present invention to provide a separation technique capable of separating a sample containing substances of various sizes within a short time. It is another object of the present invention to provide a separation technique capable of reducing costs for separating a sample containing substances of various sizes. It is another object of the present invention to provide a technique capable of stably fabricating a separation apparatus used for separating a sample containing substances of various sizes.

According to the present invention, there is provided a separation apparatus which comprises a channel through which a sample flows; a wall portion of the channel; and a sample separation region provided to the channel; wherein, in the sample separation region, the wall portion is provided with a capture portion capturing a specific component in the sample.

In the present invention, the wall portion refers to a member that partitions the interior of the channel from the exterior, and is a member covering the exterior of the channel, or a member partitions the interior of the channel. The wall portion may be composed of a single member, or a plurality of members. The capture portion refers to a region in which components of the sample is retained. The capture portion may be provided beside the channel. Components of the sample passes through the channel differ in the retention time in the capture portion depending on their sizes, so that it is made possible to allow the capture portion to capture the specific component of the sample, to thereby separate the components of the sample depending on their sizes. Because the capture portion is formed on the wall portion, the capture portion can successfully avoid damage even if the sample separation region is finely configured, and thus can precisely be fabricated. Because the damage is avoidable, the separation apparatus can be fabricated in a stable manner, and can reduce the cost. Because the capture portion is formed on the wall portion, the capture portion can be provided in various geometries depending on target samples to be separated, and this makes it possible to ensure a large difference in the retention time among components having different sizes, and consequently to improve the resolution. The improvement in the resolution can shorten the time required for the separation, and can provide a rapid separation.

The separation region of the present invention may have a plurality of capture portions formed in the separation region. This makes it possible to more correctly separate the components of the sample.

In the separation apparatus of the present invention, the capture portion may be formed normal to the direction along which the channel extends, with a small width. This allows only components having sizes not larger than a predetermined size to be captured by the capture portion, and thereby makes it possible to exactly separate the specific components of the sample. The capture portion herein may have the bottom portion thereof formed to have a circular or oval geometry. This is successful in avoiding clogging of the components of the sample, and in ensuring further accurate separation.

In the separation apparatus of the present invention, the capture portion can be formed so as to be narrowed in the opening width in a portion more distant from the center of the channel. The width herein refers to both of the widths measured in the horizontal plane and in the vertical direction to the horizontal plane of the channel of the separation apparatus. This configuration allows a smaller-sized component to go deeper into the capture portion more distant from the center of the channel, and the smaller-sized component will take a longer time for coming out from the capture portion. According to this configuration, a larger-sized component can flow more rapidly through the channel, and this makes it possible to separate the components according to their sizes in an accurate manner. Because larger-sized component can pass through the sample separation region in a relatively smooth manner as described in the above, the clogging can be avoidable and the throughput can distinctively be improved.

In the separation apparatus of the present invention, the capture portion may be formed so as to have a near-triangle geometry of the bottom surface. This configuration prevents larger-sized components from going deep into the capture portion, but allows only smaller-sized components to go deep into the capture portion, and can thereby effectively separate the sample containing components of different sizes.

In the separation apparatus of the present invention, the wall portion may have, formed thereon, a plurality of protruding portions which protrude towards the center of the channel, and the capture portion may be formed between the adjacent protruding portions.

In the separation apparatus of the present invention, the capture portion may be a pocket portion provided on the wall portion. The pocket portion herein refers to a concave region recessed in the direction away from the center of the channel. The pocket portion may hollow on the wall portion in the direction of the horizontal plane of the channel, or may hollow in the direction normal to the horizontal plane. The capture portion composing a single pocket portion may be configured by a single member. A single pocket portion may be formed in a gap surrounded by a plurality of members.

The separation apparatus of the present invention may have the channel being formed on the surface of a substrate, and having an opening; and a lid covering the opening; wherein the lid may compose a part of the wall portion; and a gap portion between the substrate and the lid may compose the capture portion. This configuration allows only smaller components to enter the capture portion provided to the gap portion between the substrate and the lid. This consequently makes it possible to efficiently separate the components of the sample according to their sizes.

In the separation apparatus of the present invention, the capture portion may be configured as extending in the direction along which the channel extends.

In the separation apparatus of the present invention, the wall portion may have a convex curved surface with respect to said capture portion. This makes it possible to narrow the width of the deep portion of the capture portion. This configuration prevents larger-sized components from going deep into the capture portion, but allows only smaller-sized components to go deep into the capture portion, and can thereby effectively separate the sample containing components of different sizes.

In the separation apparatus of the present invention, the surface of the wall portion may have a convex curved surface with respect to said capture portion. This configuration allows also relatively larger-sized components to enter the capture portion, but with finely graded degrees of penetration depending on their sizes, so that it is made possible to effectively separate the sample containing components having only slight differences among their sizes.

In the separation apparatus of the present invention, the channel may have, formed therein on the downstream side of the channel, the capture portion larger than that formed therein on the upstream side of the channel. The larger capture portion herein means that it is formed as being capable of capturing larger-sized samples. The plurality of capture portions may also be formed as being step-wisely enlarged in the direction of the sample flow through the channel. It is also allowable to arrange a plurality of capture portions of an appropriate size, between the capture portions formed as being step-wisely enlarged in the direction of the sample flow through the channel. This configuration allows a smaller-sized molecule, although being relatively large-sized one, to be captured slightly earlier by the capture portion as the sample flows further through the channel, so that the molecules can be separated according to their sizes in a more accurate manner.

In the separation apparatus of the present invention, the channel may have, formed in the channel on the downstream side of the channel, the capture portion having an opening width wider than that of the capture portion formed in the channel on the upstream side of the channel. In this configuration, the channel has a larger capturable size of the components at a further position in the direction of the sample flow, and this allows a smaller-sized molecule, although being relatively large-sized one, to be captured slightly earlier by the capture portion, so that the molecules can be separated according to their sizes in a more accurate manner.

In separation apparatus of the present invention, the channel may have, formed in the channel on the downstream side of the channel, the capture portion having a depth smaller than that of the capture portion formed in the channel on the upstream side of the channel. In this configuration, the channel has a larger capturable size of the components at a further position in the direction of the sample flow, and this allows a smaller-sized molecule, although being relatively large-sized one, to be captured slightly earlier by the capture portion, so that the molecules can be separated according to their sizes in a more accurate manner.

According to the present invention, there is provided a separation apparatus which comprises a channel through which a sample flows; a wall portion of the channel; and a sample separation region provided to the channel; wherein, in the sample separation region, the channel is provided with a plurality of expanded portions formed so as to have an expanded width as compared with the residual portion of the sample separation region.

In this configuration, the components of the sample are retained in the widened portions. This realizes a configuration in which the expanded portions can serve as the capture portion for capturing the components of the sample. The components of the sample can be separated according to their sizes, since the components of the sample differ in the retention time in the capture portion depending on their sizes.

In the separation apparatus of the present invention, the channel may have the widened portions and narrowed portions alternately arranged along the direction of the sample flow. This configuration allows the components of the sample to be retained in the widened portions, and makes difference in the retention time of the components in the capture portion, so that the components of the sample can be separated according to their sizes.

In the separation apparatus of the present invention, the sample separation region can be formed so as to be widened and narrowed in a continuous manner.

In the separation apparatus of the present invention, the sample separation region can be widened and narrowed in a step-wise manner.

According to the present invention, there is provided a separation apparatus which comprises a channel through which a sample flows; and a sample separation region provided to the channel; wherein, in the sample separation region, the channel further comprises: a partition wall; a plurality of parallel channels divided by the partition wall; and a plurality of capture portions, capturing a specific component in the sample, formed on the partition wall beside each of the plurality of parallel channels. The capture portion herein may be formed on either one of, or both of the partition wall and the side wall of the channel.

In the separation apparatus of the present invention, the capture portions in the plurality of parallel channels may be formed as having different sizes, geometries and patterns. This makes it possible to simultaneously separate the sample under various conditions.

In the separation apparatus of the present invention, the partition wall may have, formed in the partition wall, a plurality of communication portions allowing the plurality of parallel channels to communicate with each other. The communication portions herein may have a size large enough to allow molecules of small sizes to pass therethrough, out of components of the target sample to be separated by the separation apparatus according to the present invention, but may have a further small size. The communication portions herein have a function of allowing solvent to pass through the communication portions. This configuration can facilitate handling of the apparatus, by which, for example, the sample separation region which causes clogging in the region can be cleaned to resolve the clogging.

The separation apparatus of the present invention, in the sample separation region, can further comprise a width-wise external force imposing unit imposing an external force to the sample in the width-wise direction of the channel. The external force may typically be voltage, pressure and so forth. For the case where the external force is voltage, the width-wise external force imposing unit can include electrodes. Being imposed with the external force in the width-wise direction of the passageway, the components of the sample become more likely to be captured by the capture portion, so that the components in the sample can be separated in an accurate manner. For the case where the separation apparatus comprises the plurality of parallel channels partitioned by the partition wall, provision of the communication portion to the partition wall makes it possible to simultaneously impose the width-wise external force to the plurality of parallel channels, and to thereby distinctively improve the throughput.

According to the present invention, there is provided a separation apparatus which comprises a plurality of channels through which a sample flows; a plurality of sample separation regions provided to the channels; and a external force imposing unit imposing an external force to the sample in the longitudinal direction of the channels, to thereby make the sample travel through the plurality of channels at different flow rates. The external force can typically be voltage, pressure and capillary phenomenon. For the case where the external force is voltage, the external force imposing unit can include electrodes.

This configuration makes it possible to simultaneously proceed the sample separation under various conditions, and yields the effects below:

(1) In the separation of the components of the sample using the separation apparatus, the size of component which can most accurately be separated varies depending on the migration speed of the component during the process of separation. For example, the components of relatively larger sizes can accurately be separated under large migration speed. On the contrary, the components of relatively smaller sizes can accurately be separated under small migration speed. By applying different voltage values to the plurality of sample separation regions to thereby make variation in the migration speed of the sample, it is made possible to accurately separate the components having sizes equivalent to those of the components of interest.

(2) Mobility μ of the component of the sample can be expressed as v=Eμ (where, E is electric field, and v is speed of component) A more accurate mobility p can be determined based on a slope of a line expressing relations between a plurality of peak positions of the components at a plurality of sample separation regions and the applied external force.

In the separation apparatus of the present invention, the channels are grooves formed on the substrate, and the separation apparatus may further comprise a sample introduction unit introducing the sample into the channel; a sample separation region provided to each of the channels, separating the sample into a plurality of components; and a sample recovery unit analyzing or fractionating the separated sample separated by the sample separation region. This configuration allows separation, analysis and recovery of the sample to proceed on the substrate, and successfully improves the throughput. It is also made possible to reduce cost for the separation of the sample containing substances of various sizes.

According to the present invention, there is provided an analytical system detecting a specific component, which comprises any one of the separation apparatus described in the above, and a detection unit detecting the specific component separated by the separation apparatus. The analytical system herein can be configured as a mass spectral analyzer system further comprising an injection unit, an ionization unit and an analytical unit, in addition to the detection unit and the separation apparatus. The analytical system may be configured also as a GC-MS analyzer or an LC-MS analyzer comprising a GC unit or an LC device.

Target samples to be separated by the separation apparatus of the present invention include nucleic acid such as nucleic acid fragments having a variety of fine-scale sizes; organic molecules such as amino acid, peptide and protein; metal ion; colloid; and latex bead. Among others, nucleic acid or protein can more effectively be employed as the sample. Separation of these samples essentially needs a structure in which a fine-gap of several hundred nanometer level or below is provided, because small-sized molecules must be separated with a high resolution. On the other hand, it is also required to effectively suppress the clogging by giant substances. The present invention is successful in coping with both of these requirements, and is therefore suitable for the separation of nucleic acid or protein.

In the separation apparatus of the present invention, the surface of the capture portion can be covered with a hydrophilic film. The hydrophilic film may typically be a film of an oxide of a material composing the capture portion. More specifically, a possible configuration is such as using silicon as the substrate material, and providing a silicon oxide film as a hydrophilic film on the surface of the substrate formed to have a predetermined geometry. It is necessary to introduce a buffer solution (aqueous solution) and so forth into an apparatus for the sample separation, wherein the above-described configuration makes it possible to smoothly introduce the buffer solution and so forth into the apparatus. This is also effective in suppressing generation of voids, and smoothening the sample flow, in practical operation of the apparatus while introducing the buffer solution and so forth.

According to the present invention, there is provided a method of fabricating a separation apparatus comprising a sample separation region in which a capture portion capturing a specific component of a sample is formed in a channel through which the sample flows, and the method comprises forming on a substrate a groove which serves as the channel, and forming a plurality of pocket portions on the substrate in the groove; and oxidizing the surface of the plurality of pocket portions so as to grow an oxide film on the surface of each of the recesses, to thereby form the capture portion. The recess herein is formed to have a geometry as being depressed away from the center of the channel.

Because the capture portion is formed by allowing the silicon oxide film to grow in the pocket portion after forming the pocket portion typically by a lithographic process, it is made possible to form a finer structure of the capture portion as compared with the case where the capture portion is formed only by the lithographic process. For the case where there is any other surface on, or between, the opposed wall surfaces of the pocket portion, the silicon oxide films grow from these surfaces and come into contact with each other, to thereby form the capture portion having a narrower width at the portion more distant from the channel.

According to the present invention, there is provided a method of fabricating a separation apparatus comprising a sample separation region in which a capture portion capturing a specific component of a sample is formed in a channel through which the sample flows, the method comprises forming on a substrate a plurality of columnar structures so as to be spaced from each other; and oxidizing the side faces of the columnar structures so as to grow an oxide film on the side faces of the columnar structures, to thereby narrow the gap between the columnar structures and to form the capture portion. The silicon oxide film can be grown to a degree causative of contact or close approach of the adjacent columnar structures. In this configuration, the capture portion is formed between the adjacent columnar structures by allowing the silicon oxide film to grow on the surface of the columnar structures, after the plurality of columnar structures are formed by the lithographic process, so that it is made possible to form a more finer structure of the capture portion as compared with the case where the capture portion is formed only by the lithographic process.

According to the present invention, there is provided a method of fabricating a separation apparatus comprising a sample separation region in which a capture portion capturing a specific component of a sample is formed in a channel through which the sample flows, the method comprises forming a resist film on the surface of a substrate; pressing a mold surface having an irregular profile formed on the mold surface in contact with the resist film, to thereby transfer the irregular profile to the resist film; removing a portion of the resist film formed in the concave portion of the irregular profile, to thereby form resist openings; and etching the substrate through a mask composed of the resist film having the openings formed in the resist mask, to thereby form the capture portion.

According to the present invention, the irregular profile is transferred onto the resist film by pressurizing the mold surface of a die in contact therewith, so that the capture portion can accurately be formed at intervals of 200 nm or below, and even 100 nm or below. Fine-processing of this level has generally demanded a lithographic process with the aid of electron beam exposure, but has been suffered from difficulty in fully raising the productivity. The present invention is successful in getting rid of the lithographic process, and in considerably improving the productivity. It is to be noted that the resist film in the present invention is not necessarily photo-sensitive nor electron-beam-sensitive, and is preferably composed of a material which can be processed to have a desired geometry by heating or pressurizing, and has resistance against dry etching. For example, polymethyl methacrylate-base resin is preferably used. The resist film in the concave portions can be removed typically by ashing.

According to the present invention, there is provided a method of fabricating a separation apparatus comprising a sample separation region in which a capture portion capturing a specific component of a sample is formed in a channel through which the sample flows, the method comprises pressing a mold surface having an irregular profile formed on the mold surface in contact with a substrate composed of a resin material at least in the surficial portion thereof, to thereby form the capture portion in the surficial portion.

The fabrication method is successful in getting rid of the lithographic process, and in considerably improving the productivity.

According to the present invention, there is provided a method of fabricating a separation apparatus comprising a sample separation region in which a plurality of capture portions capturing specific components of a sample are formed in a channel through which the sample flows, the method comprises forming, on a substrate provided with a layer composed of silicon oxide, a layer composed of silicon on the layer composed of silicon oxide; selectively etching the layer composed of silicon; and thermally oxidizing the layer composed of silicon to thereby integrate the layer composed of silicon with the layer composed of silicon oxide. Because the surface of the channel is completely insulated from the substrate, thus-fabricated separation apparatus is effective in particular when the separation and analysis are carried out with the aid of electric field. A higher level of voltage is applicable in these cases, and this allows the separation and analysis under higher degrees of freedom.

According to the present invention, there is provided a method of fabricating a separation apparatus comprising a sample separation region in which a capture portion capturing a specific component of a sample is formed in a channel through which the sample flows, the method comprises forming on the surface of a substrate a groove which serves as the channel, and forming a pocket portion on the surface of the groove; and providing a cover on the substrate in the sample separation region, to thereby form the capture portion in a gap between the pocket portion and the cover.

The method makes it possible to fabricate the separation apparatus by a simple method in a stable manner. Furthermore, the method make it possible to drive down the cost of the fabrication of the separation apparatus.

The separation apparatus of the present invention may have a plurality of the capture portion formed in the sample separation region. This makes it possible to stably fabricate the separation apparatus capable of further accurately separating the components of the sample.

It is to be understood that it is all enough for the separation apparatus of the present invention to have the sample separation region, and that the apparatus per se may have no sample introduction region or external force imposing unit provided to the apparatus. For example, the separation apparatus of the present invention may be configured as of disposal cartridge type, which is designed for use as being incorporated into a predetermined unit.

The present invention can therefore separate the sample containing substances of various sizes with an excellent resolution.

### BRIEF DESCRIPTION OF THE DRAWINGS

FIG. 1 is a drawing showing an exemplary separation apparatus according to an embodiment;

FIG. 2 is a drawing explaining a structure of a fluid reservoir according to the exemplary embodiment;

FIG. 3 is a drawing explaining a structure of a fluid reservoir according to the exemplary embodiment;

FIG. 4 is a drawing detailing the structure of the separation channel shown in FIG. 1;

FIG. 5 is a drawing detailing the structure of the separation channel shown in FIG. 1;

FIG. 6 is a drawing explaining a method of fabricating the separation apparatus according to the embodiment;

FIG. 7 is a drawing explaining the method of fabricating the separation apparatus according to the embodiment;

FIG. 8 is a drawing explaining an another method of fabricating the separation apparatus according to the embodiment;

FIG. 9 is a drawing explaining the another method of fabricating the separation apparatus according to the embodiment;

FIG. 10 is a drawing explaining the another method of fabricating the separation apparatus according to the embodiment;

FIG. 11 is a drawing explaining a modified example of the separation channel according to an embodiment;

FIG. 12 is a drawing explaining a modified example of the separation channel according to an embodiment;

FIG. 13 is a drawing explaining a modified example of the separation channel according to an embodiment;

FIG. 14 is a drawing explaining a modified example of the separation channel according to an embodiment;

FIG. 15 is a drawing explaining a modified example of the separation channel according to an embodiment;

FIG. 16 is a drawing explaining a modified example of the separation channel according to an embodiment;

FIG. 17 is a drawing explaining a modified example of the separation channel according to an embodiment;

FIG. 18 is a drawing explaining a modified example of the separation channel according to an embodiment;

FIG. 19 is a drawing explaining a modified example of the separation channel according to an embodiment;

FIG. 20 is a drawing explaining a modified example of the separation channel according to an embodiment;

FIG. 21 is a top view detailing a structure of a separation channel according to an embodiment;

FIG. 22 is a top view detailing a structure of a separation channel according to an embodiment;

FIG. 23 is a top view detailing a structure of a separation channel according to the embodiment;

FIG. 24 is a top view detailing a structure of a separation channel according to the embodiment;

FIG. 25 is a top view detailing a structure of a separation channel according to the embodiment;

FIG. 26 is a top view showing an exemplary separation apparatus according to an embodiment;

FIG. 27 is a drawing showing a configuration of an analytical system comprising the separation apparatus;

FIG. 28 is a drawing showing a configuration of an analytical system comprising the separation apparatus;

FIG. 29 is a drawing showing a configuration of an analytical system comprising the separation apparatus;

FIG. 30 is a drawing showing a configuration of an analytical system comprising the separation apparatus;

FIG. 31 is a drawing showing an exemplary separation apparatus of the present invention;

FIG. 32 is a drawing showing a specific structure of the joint used for the separation apparatus of the present invention;

FIG. 33 is a top view showing a separation channel of an example, by a photograph taken under an electron microscope;

FIG. 34 is a drawing showing fragments of a sample used in an example;

FIG. 35 is a drawing showing results of separation in the example;

FIG. 36 is a drawing showing results of separation in the example;

FIG. 37 is a of a top view showing a separation channel of a reference example, by a photograph taken under an electron microscope;

FIG. 38 is a drawing showing results of separation in the reference example;

FIG. 39 is a drawing showing results of separation in the reference example;

FIG. 40 is a drawing showing a configuration of an analytical system comprising the separation apparatus;

FIG. 41 is a drawing showing a configuration in which a capture portion is formed at the bottom portion of the channel;

FIG. 42 is a drawing showing a configuration in which a capture portion is formed at the bottom portion of the channel;

FIG. 43 is a drawing showing results of separation in an example;

FIG. 44 is a drawing detailing a structure of a separation channel in an embodiment;

FIG. 45 is a drawing detailing a structure of a separation channel in the embodiment;

FIG. 46 is a drawing detailing a structure of a separation channel in the embodiment;

FIG. 47 is a drawing detailing a structure of a separation channel in the embodiment;

FIG. 48 is a drawing detailing a structure of a separation channel in the embodiment;

FIG. 49 is a drawing detailing a structure of a separation channel in an embodiment;

FIG. 50 is a drawing showing projections formed on a substrate in a separation channel of an embodiment; and

FIG. 51 is a drawing detailing a separation channel of an embodiment.

### PREFERRED EMBODIMENTS OF THE INVENTION

In the present invention, the channel and sample separation region can be formed on the surface of a silicon substrate, a glass substrate such as being made of quartz, or a substrate composed of plastic material such as silicone resin. In an exemplary case, a groove portion is provided to the surface of any of these substrates, enclosed with a surface member, and the channel or sample separation region can be formed within the space surrounded by these structures.

The following paragraphs will further explain embodiments of the present invention referring to the attached drawings.

(First Embodiment)

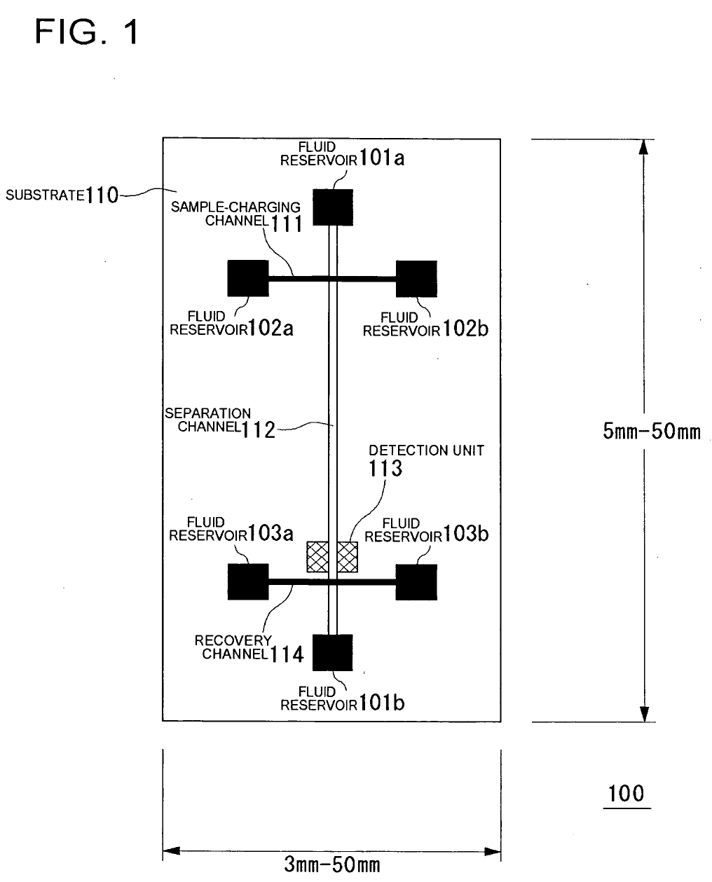

FIG. 1 is a drawing showing an exemplary separation apparatus according to a first embodiment of the present invention.

A separation channel 112 is formed on a substrate 110, and a sample-charging channel 111 and a recovery channel 114 are formed so as to cross therewith. The sample-charging channel 111, separation channel 112 and recovery channel 114 have, on their both ends, a fluid reservoir 102a, a fluid reservoir 102b, a fluid reservoir 101a, a fluid reservoir 101b, a fluid reservoir 103a and a fluid reservoir 103b, respectively. Each of these fluid reservoirs has an electrode provided thereto, with which an electric field can be applied on both ends of each of the sample-charging channel 111, separation channel 112, and recovery channel 114.

The separation channel 112 has a detection unit 113 provided thereto. The outside dimension of the apparatus can appropriately be selected depending on the purpose of use, wherein it is generally selected within ranges from 5 mm to 50 mm long, and from 3 mm to 50 mm wide as shown in the drawing.

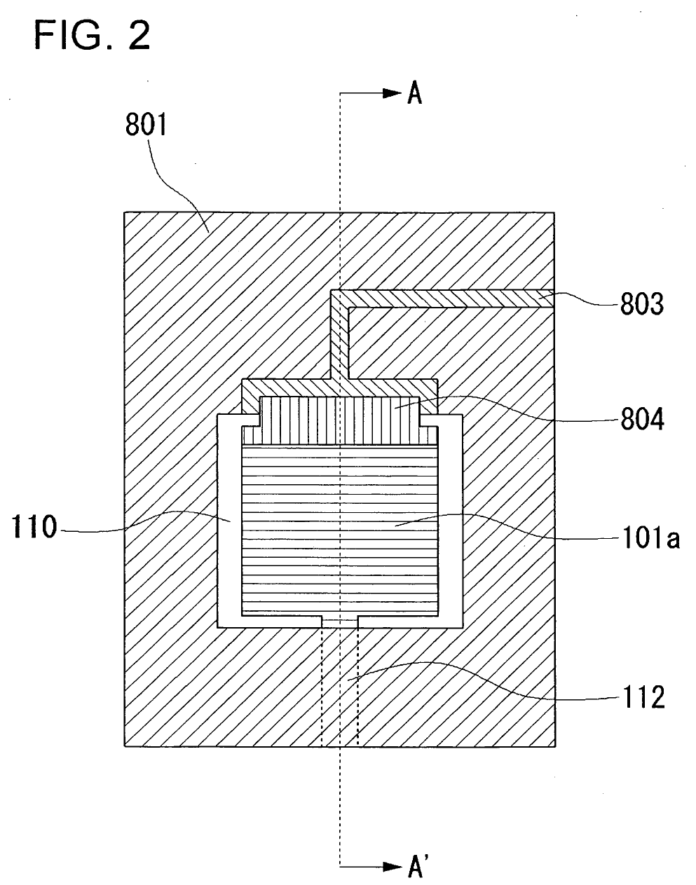

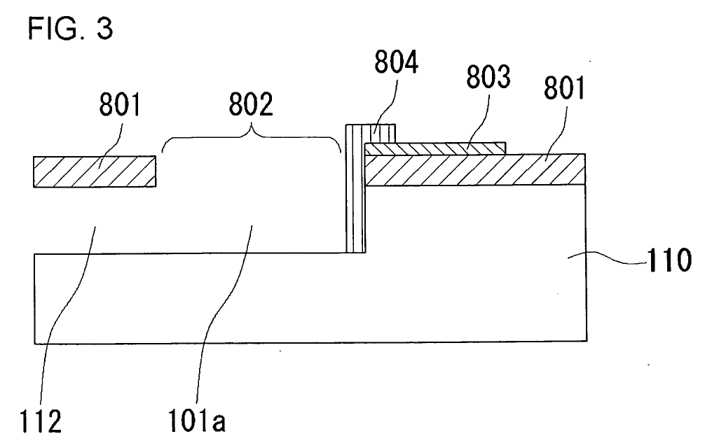

FIG. 2 is an enlarged view showing the fluid reservoir 101a and the peripherals thereof shown in FIG. 1. FIG. 3 is a sectional view taken along line A-A′ in FIG. 2. On the substrate 110 having the separation channel 112 and fluid reservoir 101a provided thereon, a cover 801 having an opening 802 allowing injection of a buffer solution therethrough is disposed. On the cover 801, a conduction route 803 allowing connection with an external power source is provided. An electrode plate 804 is disposed so as to extend along the wall surface of the fluid reservoir 101a and the conduction route 803. The electrode plate 804 and conduction route 803 are press-contacted, to thereby establish electrical connection. Other fluid reservoirs 101b, 102a, 102b, 103a and 103b have the similar structure.

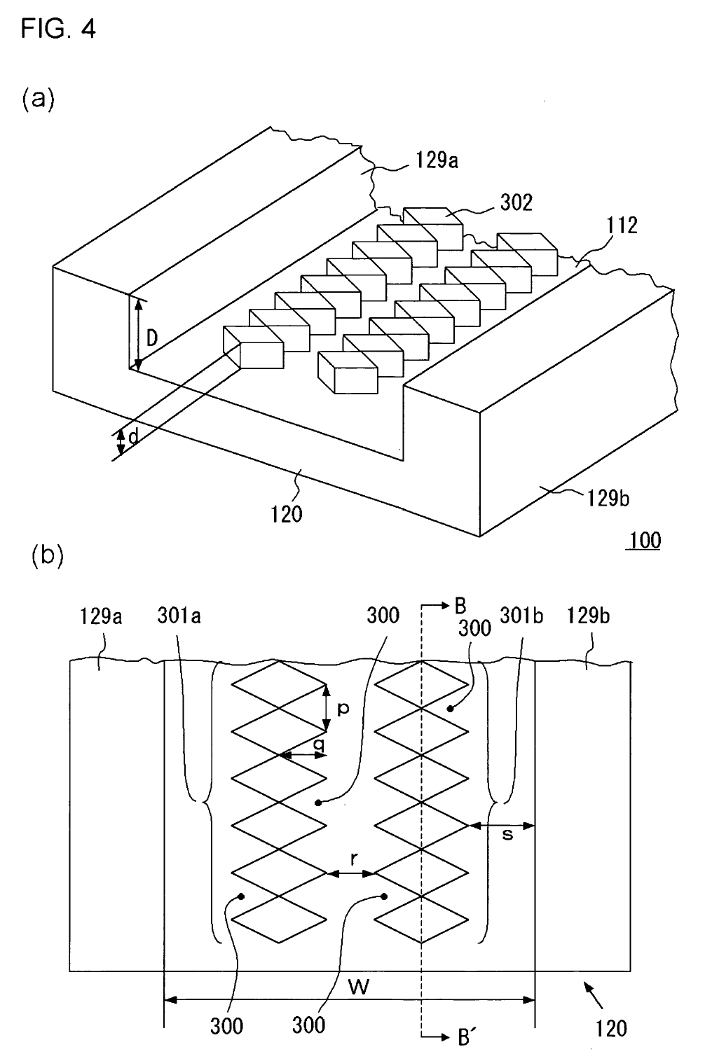

FIG. 4 is a drawing detailing the structure of the separation channel 112 of the separation apparatus 100. FIG. 4(a) is a perspective view of the separation channel 112, and FIG. 4(b) is a top view of the separation channel 112. The separation channel 112 comprises a groove portion having width W and depth D formed in the substrate 120, in which two rows of a partition wall 301a and a partition wall 301b are provided. Each of the partition wall 301a and partition wall 301b are composed of a string of a plurality of columnar structures 302. Each of the columnar structures 302 is a square pole having a rhombic bottom plane and height d. The plurality of columnar structures 302 are arranged so that a partition wall 301a and a partition wall 301b have a plurality of capture portions 300, each having opening width p and depth q, formed therebetween. Distance between the partition wall 301a and partition wall 301b is expressed as r, and distance between the partition wall 301a and channel wall 129a, or between the partition wall 301b and channel wall 129b is expressed as s. In the separation channel 112, the sample flows between the partition wall 301a and partition wall 301b, or between the partition wall 301a and channel wall 129a, or between the partition wall 301b and channel wall 129b, respectively. The individual dimensions can typically be given as below:

W: 10 μm to 30 mm;

D: 10 nm to 500 μm;

d: 10 nm to 5 μm;

p: 10 nm to 10 μm;

q: 10 nm to 10 μm;

r: 10 nm to 10 μm; and

s: 5 nm to 5 μm.

In this embodiment, width W and depth D of the groove portion, height d of the columnar structure 302, opening width p and depth q of the capture portion 300, distance r between the partition wall 301a and partition wall 301b, and distance s between the partition wall 301a or partition wall 301b and the channel wall 129a or channel wall 129b are appropriately selected as being adapted to size of components to be separated (organic molecules such as nucleic acid, amino acid, peptide and protein; molecules such as chelated metal ion; and ion). Exemplary selections can be listed below.

(i) Separation and condensation of cells and other components

W: 3 mm to 30 mm;

D: 1 μm to 500 μm;

d: 1 μm to 500 μm;

p: 1 μm to 10 μm;

q: 1 μm to 10 μm;

r: 1 μm to 10 μm; and

s: 500 nm to 5 μm.

(ii) Separation and condensation of solid matter (fragment of cell membrane, mitochondria, endoplasmic reticulum) and liquid fraction (cytoplasm), out of components obtained by destruction of cells

W: 300 μm to 3 mm;

D: 100 nm to 50 μm;

d: 100 nm to 50 μm;

p: 100 nm to 1 μm;

q: 100 nm to 1 μm;

r: 100 nm to 1 μm; and

s: 50 nm to 500 nm.

(iii) Separation and condensation of high-molecular-weight components (DNA, RNA, protein, sugarchain) and low-molecular-weight components (steroid, glucose, and so on), out of components of liquid fraction

W: 30 μm to 300 μm;

D: 10 nm to 5 μm;

d: 10 nm to 5 μm;

p: 10 nm to 100 nm;

q: 10 nm to 100 nm;

r: 10 nm to 100 nm; and

s: 5 nm to 50 nm.

For example, too large distance r between the partition wall 301a and partition wall 301b, or too large distance s between the partition wall 301a or partition wall 301b and the channel wall 129a or channel wall 129b may result in insufficient separation of smaller-sized molecules, whereas too small distance r or s may make clogging more likely to occur. Appropriate selection of these sizes can further raise the resolution.

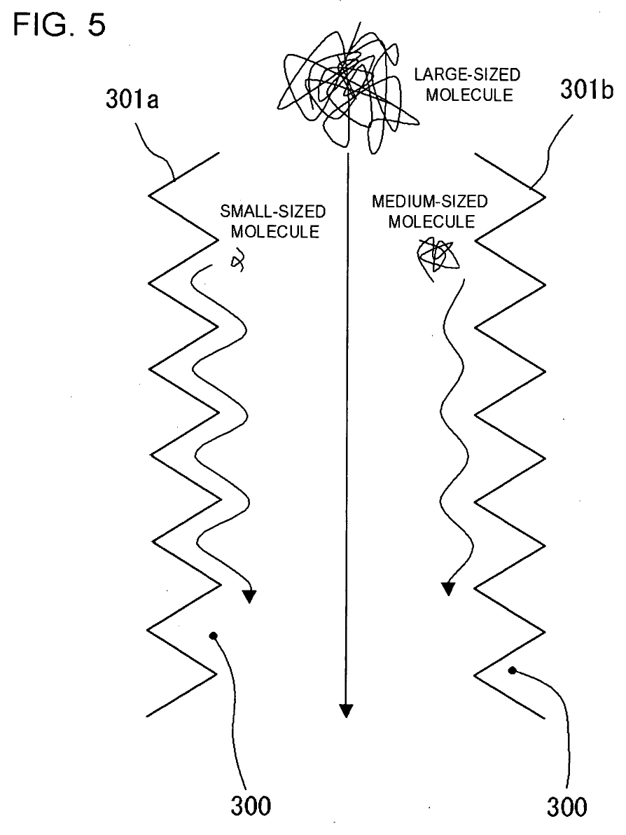

FIG. 5 is a schematic drawing showing how the sample passes between two partition walls 301a and 301b. About the capture portion 300, as shown in FIG. 5, a smaller molecule can go more deeply into the capture portion 300, and consequently takes a longer time to come out of the capture portion 300. This allows larger molecules to pass through the separation channel 112 of this embodiment faster than smaller molecules. It is because molecules of smaller sizes travel a longer way routed deep inside the capture portion 300, whereas molecules of larger sizes travel smoothly between the partition walls 301. This results in separation in a style such that the smaller-sized substances are ejected after the larger-sized substances. The larger-sized substances can pass through the separation region in a relatively smooth manner, so that the clogging is avoidable, and the throughput is distinctively improved.

Although the description in the above was made referring to the drawing showing the case where two partition walls 301a and partition wall 301 were disposed in the separation channel 112, it is also allowable to provide two or more partition walls, or only a single partition wall. The channel wall 129a and channel wall 129b may be configured also as having a plurality of capture portions 300 provided thereto. In this case, the separation channel 112 may not be provided with the partition wall. Although the partition wall described in the above was configured as having the capture portions 300 on both side faces thereof, it is also allowable to configure the partition wall as having the capture portions 300 on only one side face thereof.

Now referring back to FIG. 1, a method of separating the sample using the separation apparatus 100 will be described. First, the sample is injected to the fluid reservoir 102a or the fluid reservoir 102b. Voltage is applied so as to make the sample flow towards the fluid reservoir 102b when the sample is injected into the fluid reservoir 102a, whereas voltage is applied so as to make the sample flow towards the fluid reservoir 102a when the sample is injected into the fluid reservoir 102b. This makes the sample enter the sample-charging channel 111, and consequently fill the entire portion of the sample-charging channel 111. On the separation channel 112 at this point of time, the sample resides only at the intersection with the sample-charging channel 111, and forms a band approximately as narrow as the width of the sample-charging channel

Next, the voltage application between the fluid reservoir 102a and fluid reservoir 102b is interrupted, and voltage is then applied between the fluid reservoir 101a and fluid reservoir 101b, so as to make the sample flow towards the fluid reservoir 101b. This makes the sample flow through the separation channel 112. The sample advances through the separation channel 112 at a speed depending on the molecular size and intensity of electric charge. As a consequence, the different molecular groups of the sample are separated into bands respectively migrating at different speeds. Thus-separated bands reach the detection unit 113, and are detected by an optical method, or by other physicochemical methods. The optical detection herein means that, for example, a fluorescent substance is preliminarily bound to a molecule, and that the detection unit 113 is used to irradiate a laser light to the molecule and to observe the fluorescence emitted therefrom. The separated bands can further be collected by band. The voltage application between the fluid reservoir 101a and fluid reservoir 101b is interrupted at a sign of passage of a desired band through the detection unit 113, and instead, voltage is applied between the fluid reservoir 103a and fluid reservoir 103b. This makes the band, which resides in the separation channel 112 and at the inter intersection with the recovery channel 114, enter the recovery channel 114. Upon interruption of the voltage application between the fluid reservoir 103a and fluid reservoir 103b after the elapse of a predetermined time period, the desired molecule contained in the separated band is recovered in the fluid reservoir 103a or fluid reservoir 103b.

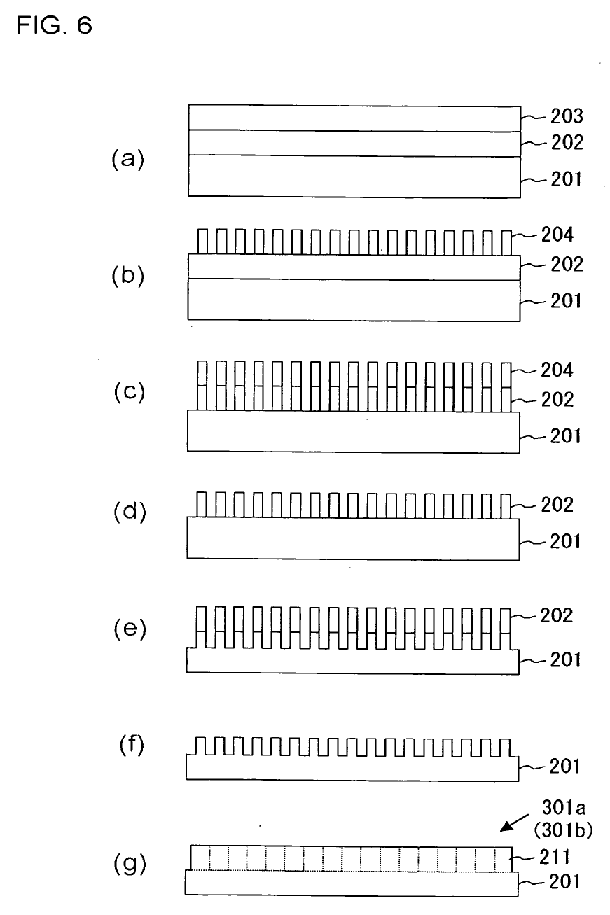

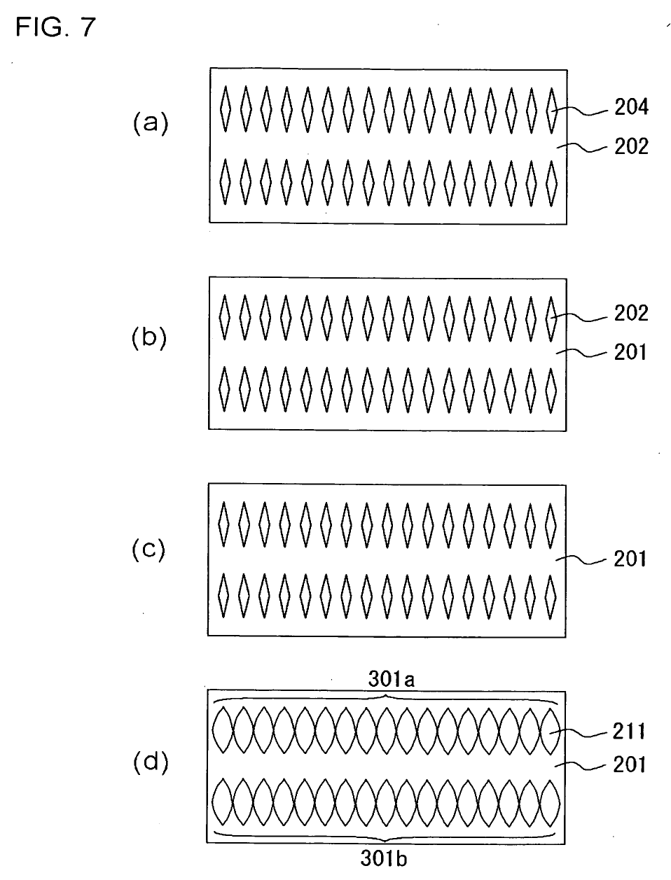

Next paragraphs will describe a method of fabricating the separation apparatus 100 of this embodiment, referring to FIG. 6 and FIG. 7. The separation apparatus 100 is obtained by providing the groove portions (not shown) to the surface of the a silicon substrate 201 to thereby form the sample-charging channel 111, separation channel 112, recovery channel 114, fluid reservoirs 101a, 101b, 102a, 102b, 103a and 103b shown in FIG. 1, and then by forming the sample separation region at a predetermined position of the separation channel 112. A method of fabricating the sample separation region of the separation channel 112 will be described below. FIG. 6 herein shows a section taken along line B-B′ in the structure of the separation channel 112 shown in FIG. 4(b), and FIG. 7 shows a top view of the structure of the separation channel 112 shown in FIG. 4(b). First, as shown in FIG. 6(a), on the silicon substrate 201, a silicon dioxide film 202, and a calixarene electron beam negative resist 203 are formed in this order. Values of the thicknesses of the silicon dioxide film 202 and calixarene electron beam negative resist 203 are set to 40 nm and 65 nm, respectively.

Next, regions of the partition wall 301a and partition wall 301b of the separation channel 112 are exposed by an electron beam (EB). The resist is developed using acetone, and rinsed using ethanol. The process results in a patterned resist 204 as shown in FIG. 6(b). The top view observed at this stage is shown in FIG. 7(a).

Next, the silicon dioxide film 202 is etched by RIE using a mixed gas of CF₄ and CHF₃ (FIG. 6(c)). The resist is removed by organic cleaning using a mixed solution of acetone, alcohol and water, and is subjected to oxidative plasma processing (FIG. 6(d)). The top view observed at this stage is shown in FIG. 7(b). Next, the silicon substrate 201 is subjected to ECR etching using an HBr gas. Etching depth of the silicon substrate 201 resulted after the etching can be adjusted within a range from 400 nm to 1 μm, for example (FIG. 6(e)). Next, wet etching using a BHF, buffered hydrofluoric acid, is carried out to remove the silicon dioxide film 202 (FIG. 6(f)). The top view observed at this stage is shown in FIG. 7(c).

Succeeding thermal oxidation by annealing of the silicon substrate 201 causes oxidation of the surface of the silicon substrate 201 to produce an oxide film 211, and this allows the columnar structures to expand, and allows the adjacent columnar structures to contact with each other, to thereby form the partition wall 301a and partition wall 301b (FIG. 6(g)). The top view observed at this stage is shown in FIG. 7(d). As described in the above, annealing of the surface of the silicon substrate 201 can impart hydrophilicity to the separation channel 112. By these processes, the structure of the separation channel 112 shown in FIG. 4 is fabricated.

The hydrophylization treatment of the surface of the silicon substrate 201 can be proceeded also, for example by coating a coupling agent having a hydrophilic group, or through chemical oxidation by making the substrate contact with a chemical solution. The chemical oxidation of the surface of the silicon substrate is preferable, in view of its capability of forming a uniform thin film. An exemplary method of the chemical oxidation is such as using a concentrated nitric acid, by which a thin film of as thin as 2 nm can be formed.

It is further preferable to subject the channel wall to adhesion-proof treatment in order to prevent adhesion of DNA, protein and so forth. This allows the separation apparatus to exhibit a desirable separation ability. An exemplary adhesion-proof treatment is such as coating a substance, structurally analogous to phospholipid composing cell membrane, on the channel wall. This sort of substance can be exemplified by Lipidure (registered trademark, product of NOF Corporation). Lipidure (registered trademark) is used as being dissolved in a buffer such as TBE (Tris-Boric acid-EDTA) with a concentration of 0.5 wt %, the resultant solution is filled in the channel, and allowed to stand for several minutes, so as to coat the channel. For the case where the component to be recovered is a biological component such as protein, this way of coating successfully exhibits an effect of preventing denaturation of the component, suppresses non-specific adsorption of the component onto the channel of the apparatus, and thereby can improve the recovery yield. It is also made possible to prevent molecules such as DNA from adhering on the channel wall, by coating a fluorine-containing resin or bovine serum albumin on the channel wall.

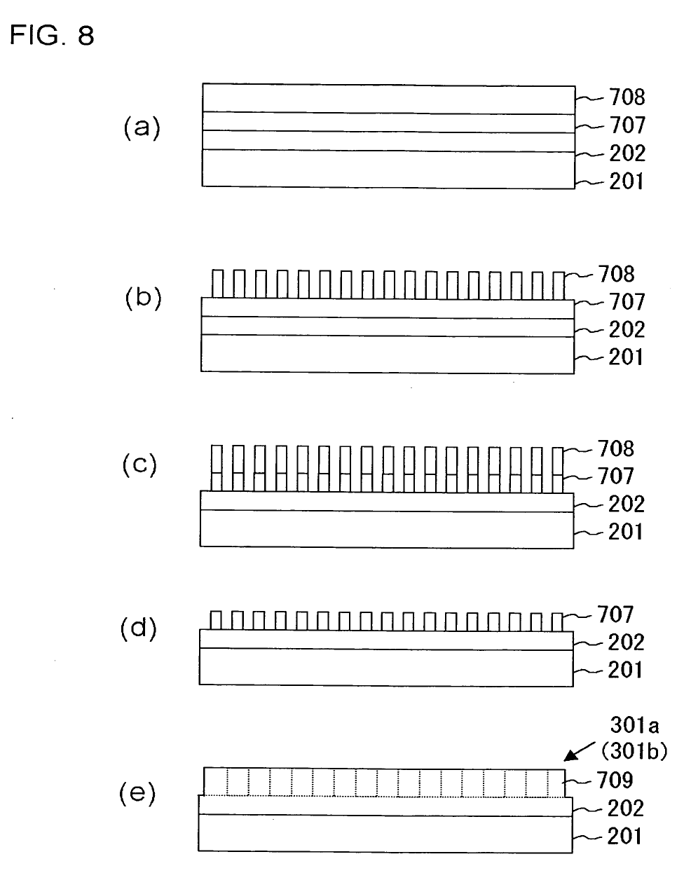

Next paragraphs will explain another method of fabricating the separation apparatus 100 of this embodiment, referring to FIG. 8. The thermal oxidation of the silicon substrate 201 explained in the above referring to FIG. 6(g) may sometimes result in only an insufficient formation of the film depending on the oxidation conditions. This may be causative of current leakage to the substrate, and means that a necessary level of electric field cannot be obtained when the sample is separated by electrophoresis. To avoid this problem, it is also allowable to fabricate the separation apparatus 100 as described in the next.

First, the silicon substrate 201 is thermally oxidized to thereby form the silicon dioxide film 202. Polysilicon is then deposited on the silicon dioxide film 202, to thereby form a polysilicon film 707. Next, the polysilicon film 707 is thermally oxidized to thereby form an oxide film 708 (FIG. 8(a)).

Next, a calixarene electron beam negative resist is formed on the oxide film 708, and the resist is then patterned by pattern exposure of the regions thereof corresponded to the fluid reservoirs and sample channels, using electron beam (EB). Thereafter, the oxide film 708 is etched by RIE etching through the resist as a mask, and the resist is then removed (FIG. 8(b)). Next, the polysilicon film 707 is subjected to ECR etching through thus-etched oxide film 708 as a mask (FIG. 8(c)). Thereafter, the oxide film 708 is removed (FIG. 8(d)). Succeeding thermal oxidation by annealing of thus-etched polysilicon film 707 causes oxidation of the surface of the polysilicon film 707 to produce an oxide film 709, and this allows the columnar structures to expand, and allows the adjacent columnar structures to contact with each other, to thereby form the partition wall 301a and partition wall 301b (FIG. 8(e)). The oxide film 709 herein is integrated with the silicon dioxide film 202.

The separation channels processed as described in the above are completely insulated from the silicon substrate 201, and this make it possible to completely secure the electric field for the electrophoresis.

It is to be understood that the silicon substrate 201 and silicon dioxide film 202 in the above-described embodiment can be substituted by a quartz substrate. It is also allowable to use an SOI (Silicon On Insulator) substrate in place of the silicon substrate 201, silicon dioxide film 202 and polysilicon film 707.

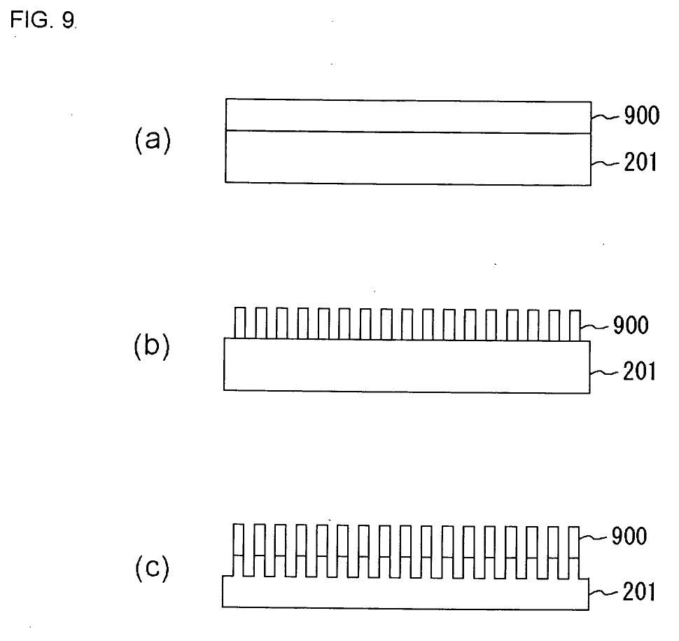

A still another method of fabricating the separation apparatus 100 of this embodiment will be explained referring to FIG. 9. A separation channel 112 of the separation apparatus 100 can be formed also by directly etching the silicon substrate 201 through a resist mask. First, a resist 900 is formed on the silicon substrate 201 (FIG. 9(a)), the resist is patterned (FIG. 9(b)), and, by using the resultant pattern as a mask, the silicon substrate 201 is etched (FIG. 9(c)). The succeeding processes can be carried out by techniques similar to those previously explained referring to FIG. 6(f) and FIG. 6(g).

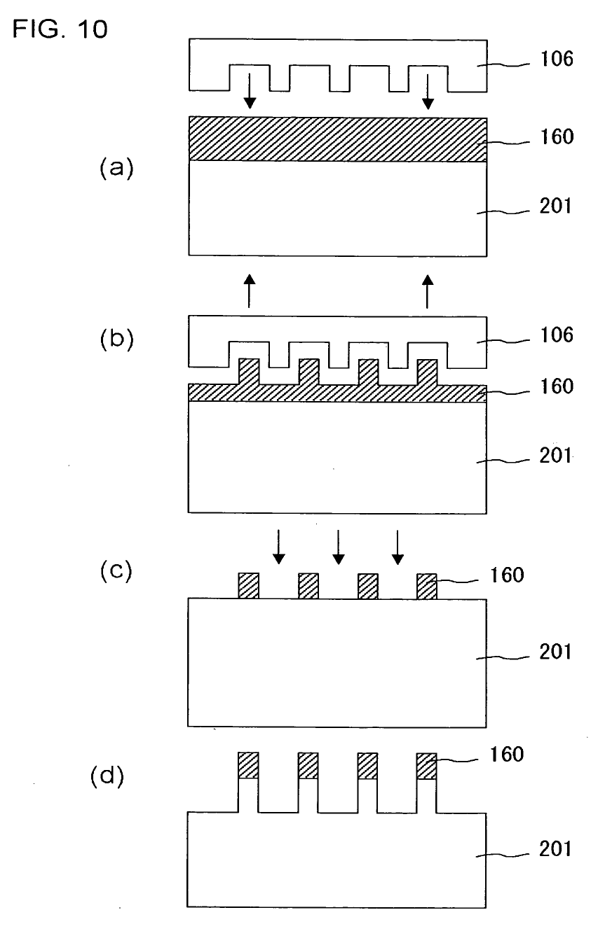

A still another method of fabricating the separation of this embodiment will be explained referring to FIG. 10. The separation channel 112 of the separation apparatus 100 can be formed also by the nano-imprinting technique in which a master plate such as irregularly-profiled die is pressed onto a resist or the like on the substrate, to thereby pattern the mask. First, as shown in FIG. 10(a), the silicon substrate 201 composed of silicon, having a resin film 160 formed thereon, and a die 106 having a mold surface processed to have a convexoconcave are obtained. The irregular geometry of the mold surface of the die 106 is such as that shown in FIG. 7(a). A material composing the resin film 160 is a polymethyl methacrylate-base material, and the thickness thereof is adjusted to 200 nm or around. There is no special limitation on a material composing the die 106, wherein Si, SiO₂, SiC and so forth are applicable.

Next, as shown in FIG. 10(b), the mold surface of the die 106 is brought into contact with the surface of the resin film 160 and is pressed under heating. The pressure is adjusted to 600 to 1900 psi or around, and the temperature is adjusted to 140 to 180° C. or around. Thereafter, the substrate is released from the mold, and subjected to oxygen plasma ashing, to thereby pattern the resin film 160 (FIG. 10(c)).

Next, the silicon substrate 201 is dry-etched through the resin film 160 as a mask. Etching gas used herein is a halogen-base gas, for example (FIG. 10(d)). The succeeding processes can be carried out by techniques similar to those previously explained referring to FIG. 6(f) and FIG. 6(g).

By these processes, the structure of the separation channel 112 shown in FIG. 4 is fabricated. This embodiment is successful in getting rid of formation process of mask opening portions by electron beam exposure, and can distinctively improve the productivity.

In still another example of a method of fabricating the separation apparatus 100, the columnar structures 302 can directly be formed using a die. More specifically, a predetermined plastic material is coated on the substrate, and the material can be molded by processes same as those shown in FIG. 10. In this case, the irregular geometry of the die 106 is such as that shown in FIG. 7(d) The plastic material coated on the substrate is preferably such as having a desirable moldability, and an appropriate level of hydrophilicity. Preferable examples of which include polyvinylalcohol-base resin, and in particular ethylene-vinyl alcohol resin (EVOH), polyethylene terephthalate, and polydimethyl siloxane (PDMS). Even hydrophobic resins are applicable, because the surface of the passageway is made into hydrophilic if the above-described coating is provided after the molding.

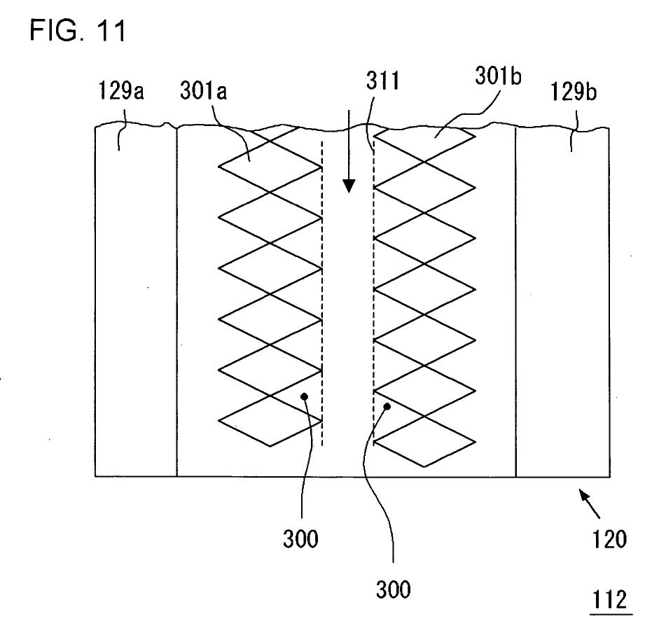

Next paragraphs will explain a modified example of the separation channel 112 shown in FIG. 4, referring to FIG. 11 to FIG. 16.

The exemplary case shown in FIG. 4 has two partition wall 301a and partition wall 301b arranged so that the individual capture portions 300 thereof are opposed with each other, whereas it is also allowable, as shown in FIG. 11, to arrange the partition wall 301a and partition wall 301b so that the individual capture portions 300 thereof are staggered on the left and right of the channel. In this configuration, larger-sized molecules pass through a main channel 311 indicated by broken lines in the drawing, whereas smaller-sized molecules can go more deeply into the capture portions 300, and consequently take a longer time to come out of the capture portions 300. Therefore also in this example, the components of the sample can be separated by the separation channel 112.

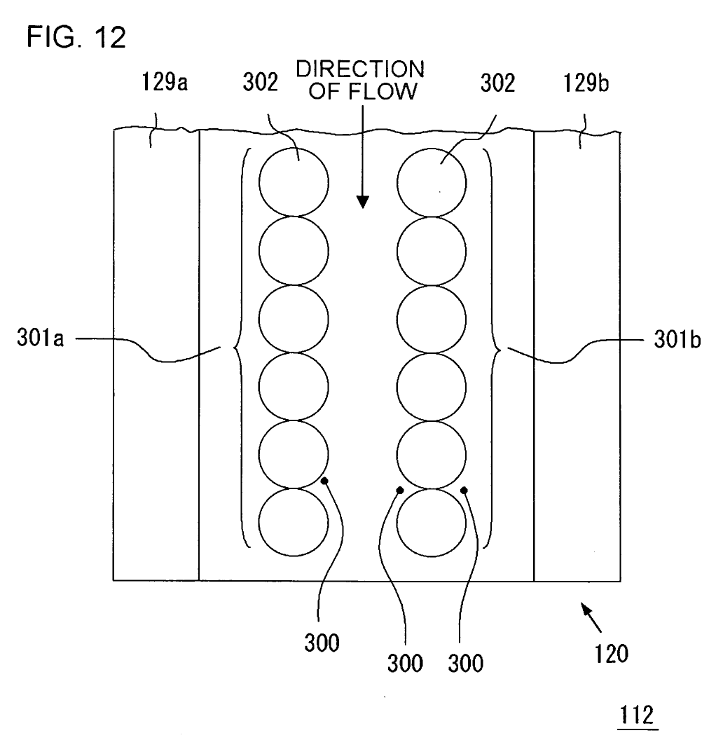

In the separation channel 112, it is still also allowable, as shown in FIG. 12, to configure the plurality of columnar structures 302, respectively composing the partition wall 301a and partition wall 301b, as cylinders each having a circular bottom plane. This configuration allows the capture portion 300 to have a convex curved surface. According to this configuration, larger-sized molecules will never go deep into the capture portion 300, but smaller-sized molecules can go deep into the capture portion 300, and this makes it possible to effectively separate the sample containing components largely differ in their sizes. Although the columnar structures 302 herein were given as cylinders each having a circular bottom plane, the cylinders may be such as those each having an oval bottom plane.

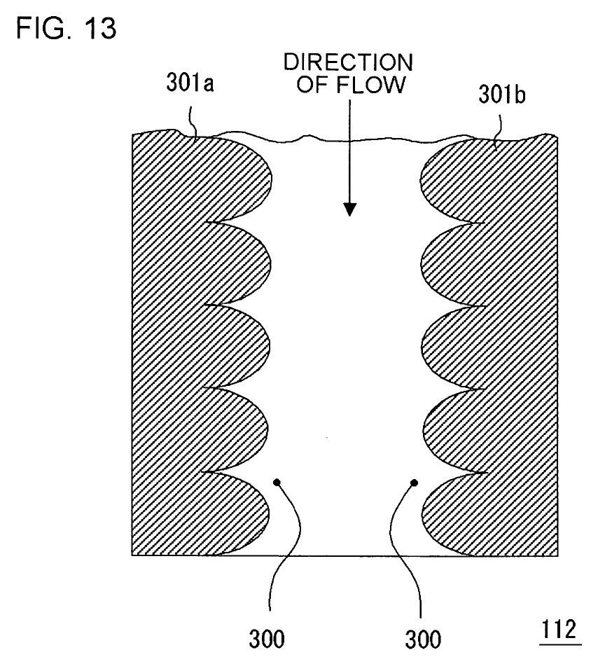

The partition wall 301a and partition wall 301b may not always be configured as containing a plurality of columnar structures 302, but also may be configured, as shown in FIG. 13, so that the capture portions 300 have a convex curved surface. Also this case is successful in effectively separate the sample containing components largely differ in their sizes, similarly to the case shown in FIG. 12.

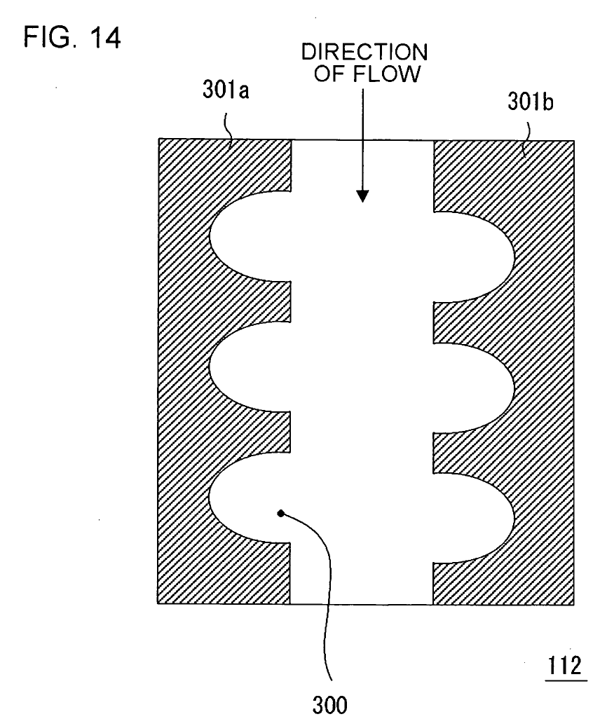

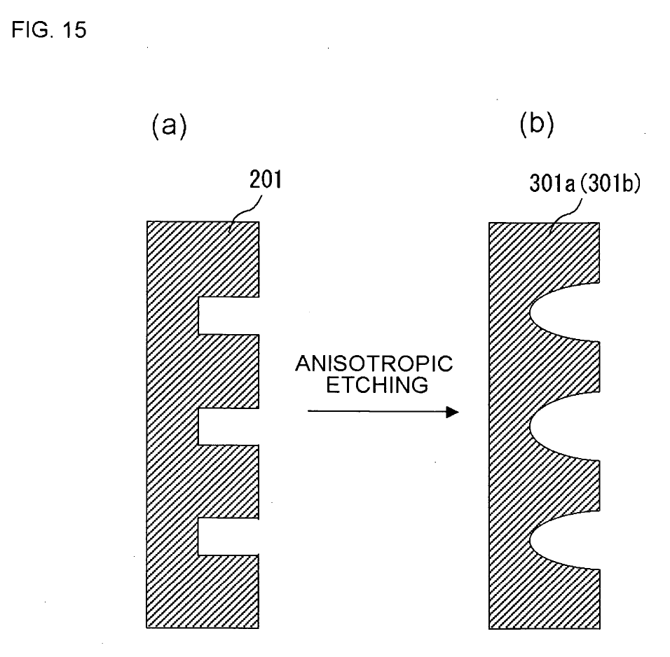

It is still also allowable to configure the partition wall 301a and partition wall 301b so that the capture portions 300 have a concave curved surface, as shown in FIG. 14. According to this configuration, also larger-sized molecules may enter the capture portions 300, but degree of depth of entering slightly varies by size, and this makes it possible to separate the sample containing components not so largely differ in their sizes. This sort of partition wall 301a and partition wall 301b can be formed by electron beam exposure using a mask having a predetermined pattern. It is also possible, as shown in FIG. 15, to form rectangular concaves to the silicon substrate 201 (FIG. 15(a)), and then form the capture portions 300 having a concave curved surface by isotropic etching (FIG. 15(b)).

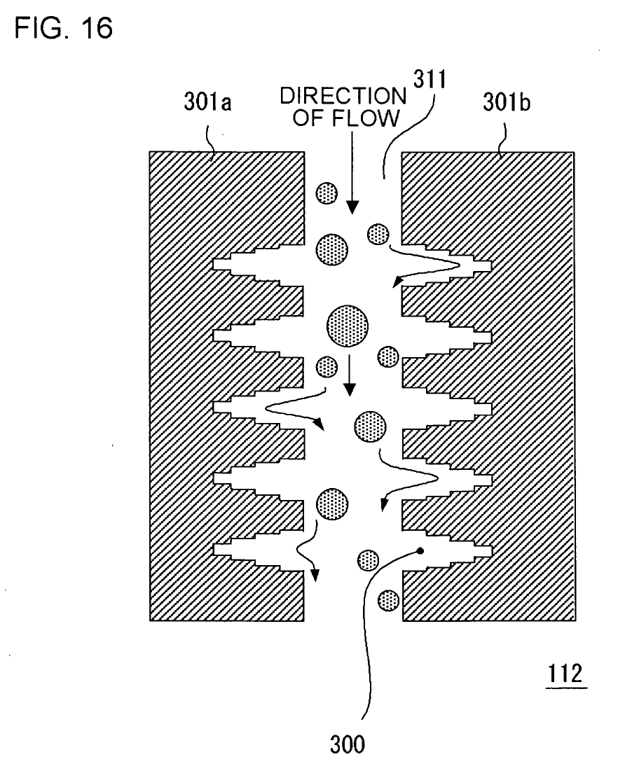

It is still also allowable, as shown in FIG. 16, to form the partition wall 301a and partition wall 301b so that the capture portions 300 are step-wisely narrowed in the direction departing from the main channel 311. In this configuration, smaller molecules can go deeper into the capture portions 300, and take a longer time to come out from the capture portions 300. This makes it possible to effectively separate components of different sizes.

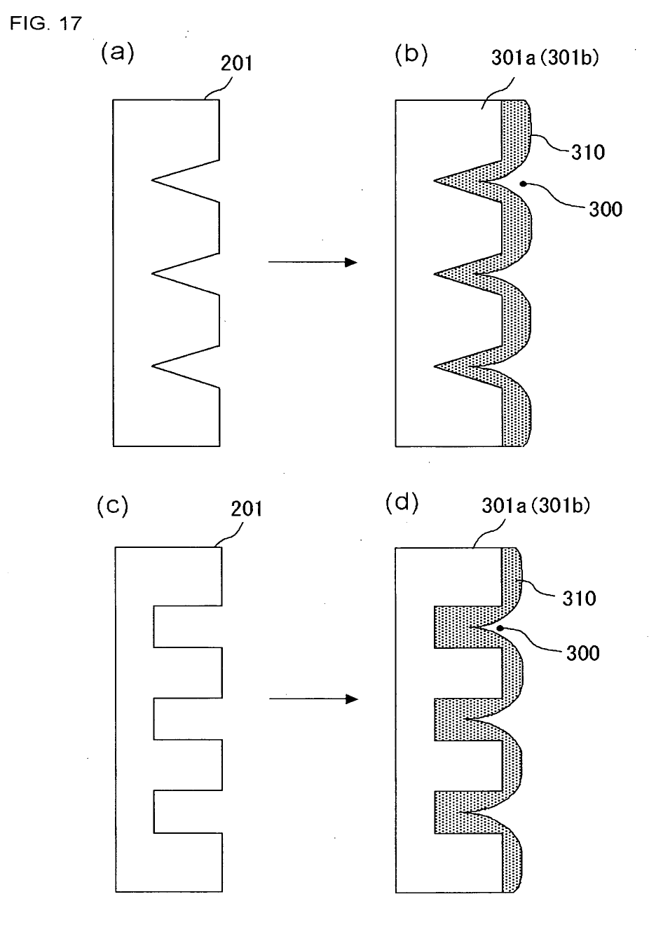

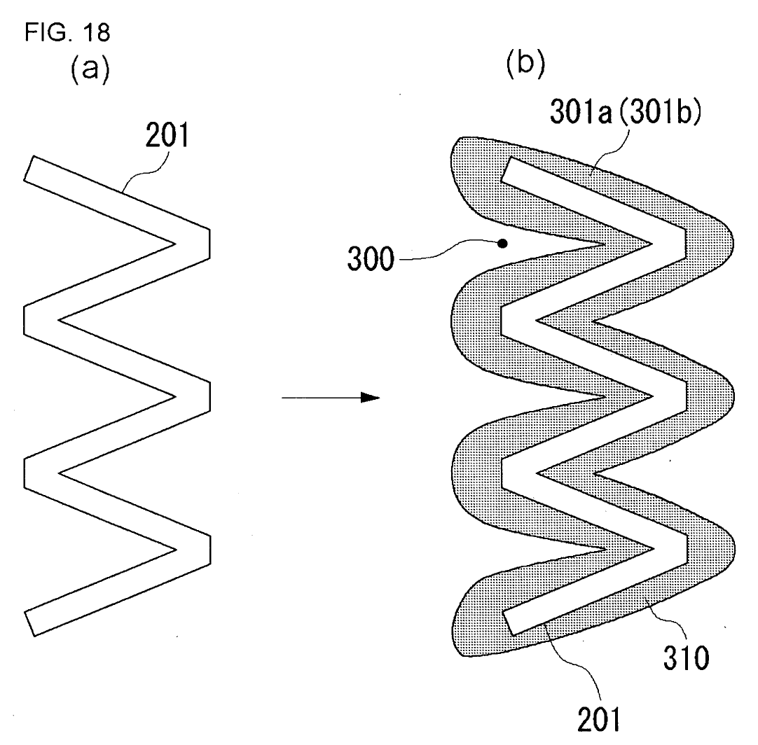

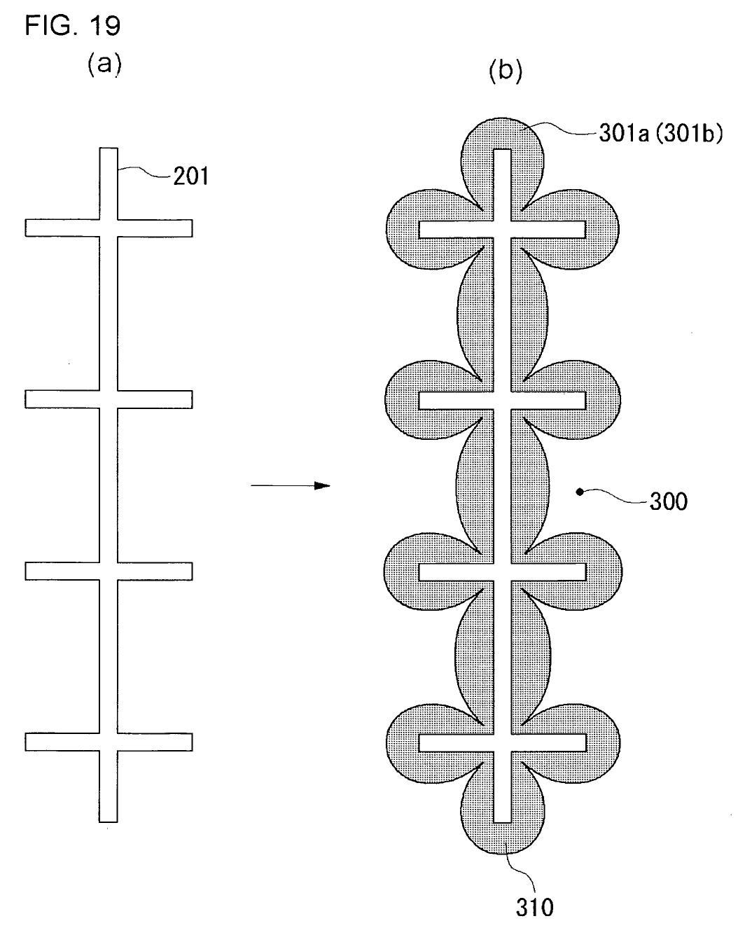

It is still also allowable to make the partition wall 301a and partition wall 301b have geometries shown in FIG. 17 to FIG. 19. In these cases, the silicon substrate 201 is etched after the lithographic process to have predetermined geometries respectively shown in FIG. 17(a), FIG. 18(a) and FIG. 19(a), and an oxide film 310 is formed by oxidizing the side surfaces of the silicon substrate 201. This makes it possible to form the partition wall 301a (or partition wall 301b) having the capture portion 300 with a narrow width as shown in FIG. 17(b), FIG. 18(b) and FIG. 19(b). In an exemplary case where the pocket portions are formed as a fine structure as shown in FIGS. 17(c) and (d), the silicon oxide film is grown from the opposing wall surfaces of each pocket portions and from the surface therebetween, so as to allow these silicon dioxide film to come into contact with each other, and thereby the capture portions 300 are formed so as to be narrowed in the direction departing from the channel. This makes it possible to form fine capture portions 300 which cannot be processed by lithography.

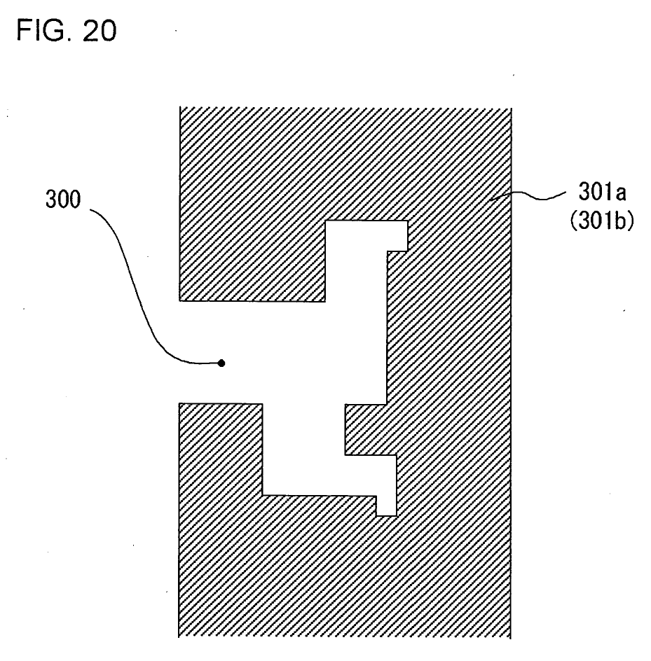

It is still also allowable to form the capture portions 300 so as to have a geometry narrowed in the width in deeper portion as shown in FIG. 20. In this configuration, smaller molecules can go deeper into the capture portions 300, and take a longer time to come out from the capture portions 300. This makes it possible to effectively separate components of different sizes.

(Second Embodiment)

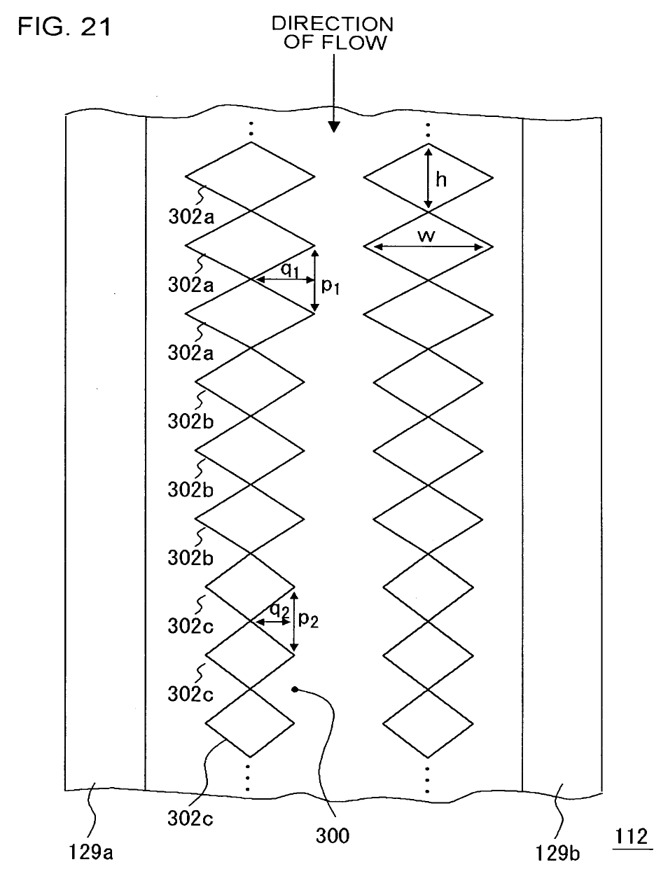

FIG. 21 is a top view detailing a structure of the separation channel 112 according to this embodiment. A general configuration of the separation apparatus of this embodiment is similar to that of the separation apparatus 100 shown in FIG. 1. Also in this embodiment, similarly to the separation channel 112 in the first embodiment, the separation channel 112 has two partition wall 301a and partition wall 301b provided thereto. The partition wall 301a and partition wall 301b are respectively formed so as to have a plurality of capture portions 300, wherein the opening ratio (opening width/depth) of the capture portions 300 increases in the advancing direction of flow in the separation channel 112. Also in this embodiment, the partition wall 301a and partition wall 301b are formed by a series of a plurality of columnar structures 302a, 302b and 302c. The columnar structures 302a, 302b and 302c are square poles each having a rhombic bottom plane. The columnar structures 302a, 302b and 302c are formed so that the one disposed at the more advanced position in the direction of flow in the separation channel 112 has a larger angle at the acute angle portion of the rhombus. The columnar structures 302a, 302b and 302c herein are formed as having an equal height h, but the ones disposed at the more advanced positions in the direction of flow in the separation channel 112 have a smaller width w.

In this configuration, for example, the opening ratio (opening width p1/depth q1) of the capture portions 300 formed between the columnar structures 302a is smaller than the opening ratio (opening width p2/depth q2) of the capture portions 300 formed between the columnar structures 302c placed at more advanced positions in the direction of flow in the separation channel 112. By reducing the opening ratio of the capture portions 300 near the sample introduction region of the separation channel 112 as described in the above, larger-sized molecules are not captured by the capture portions 300 near the sample introduction region, and rapidly go forward in the direction of flow in the separation channel 112. Because the opening ratio of the capture portions 300 becomes larger as the sample advances further in the separation channel 112, smaller-sized molecules, although being relatively large-sized ones, can gradually be captured by the capture portions 300, and this makes it possible to more accurately separate the molecules by their sizes.

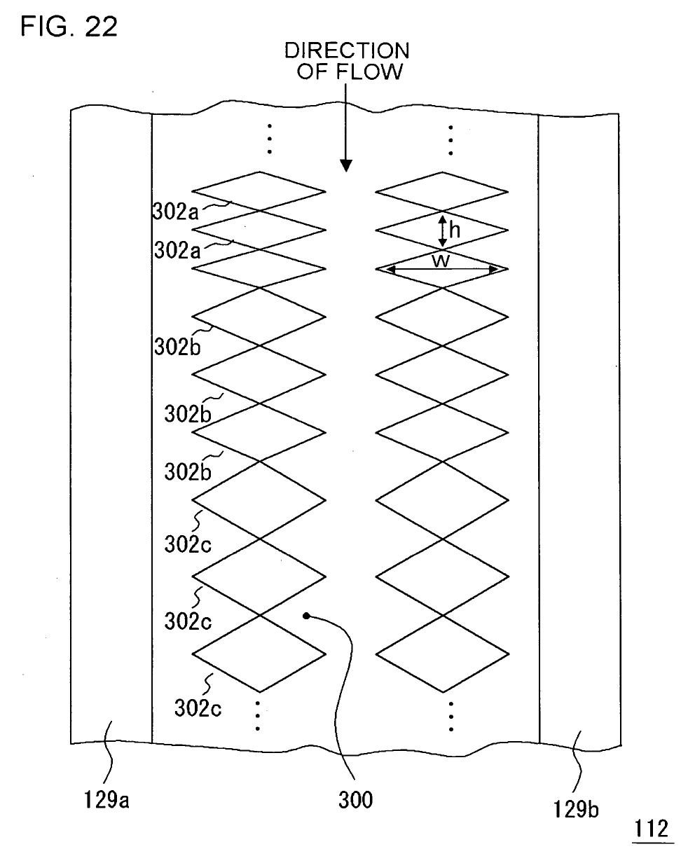

Although the individual columnar structures 302a, 302b and 302c in the above-described embodiment are configured as having an equal height h, and being narrowed in the width w of the columnar structures 302a, 302b and 302c at further positions in the direction of flow in the separation channel 112, it is also allowable, as shown in FIG. 22, to make the individual columnar structures 302a, 302b and 302c have an equal width w, but an increased height h of the columnar structures 302a, 302b, and 302c at the further position in the direction of flow in the separation channel 112.

It is not always necessary to configure the partition wall 301a and partition wall 301b as having a plurality of columnar structures 302, but may be configured as plate-like partition walls having concave portions or convex portions formed thereon. Also in this case, the partition walls may contain the capture portions 300 formed so as to capture larger-sized molecules at further positions in the direction of flow in the separation channel 112.

(Third Embodiment)

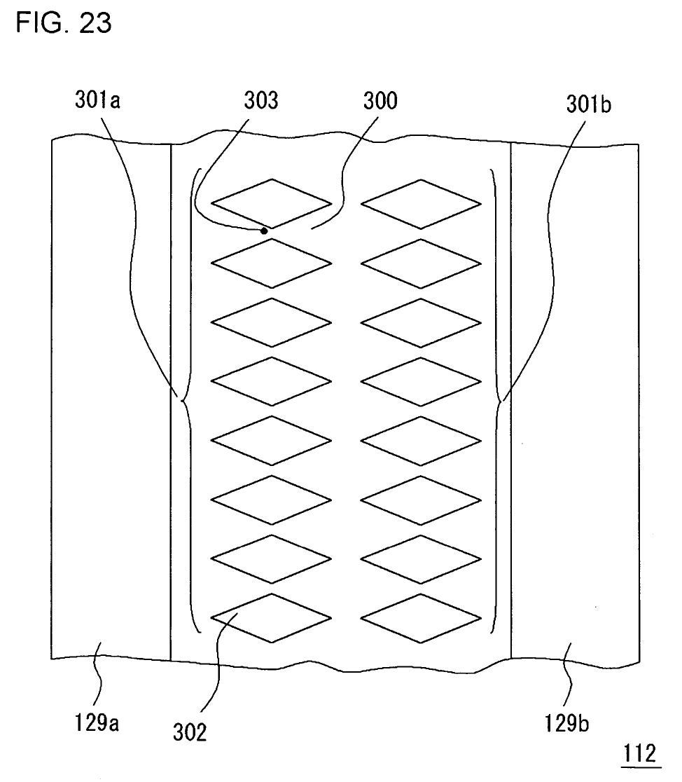

FIG. 23 is a top view detailing a structure of the separation channel 112 according to this embodiment. A general configuration of the separation apparatus of this embodiment is similar to that of the separation apparatus 100 shown in FIG. 1. Also in this embodiment, similarly to the separation channel 112 in the first embodiment, the separation channel 112 has two partition wall 301a and partition wall 301b provided thereto. Also the partition wall 301a and partition wall 301b herein are respectively composed of a plurality of columnar structures 302, and consequently have a plurality of capture portions 300. In this embodiment, the partition wall 301a and partition wall 301b are differed from those in the first embodiment and second embodiment, in that they have a plurality of communication portions 303 formed thereto. This allows communication of the channel between the partition wall 301a and partition wall 301b, the channel between the partition wall 301a and channel wall 129a, and a channel between the channel wall 129b and partition wall 301b. The communication portions 303 may be formed as large as allowing only smaller-sized molecules, out of components in the target sample to be separated by the separation apparatus 100 of this embodiment, to pass therethrough, but also may be formed with a further smaller size. Because this way of provision of the communication portions 303 to the partition wall 301a and partition wall 301b as described in the above can promote movement of fluid between the channels, the handling can be simplified, for example, such that any clogging occurred in the separation channel 112 can be solved by cleaning.

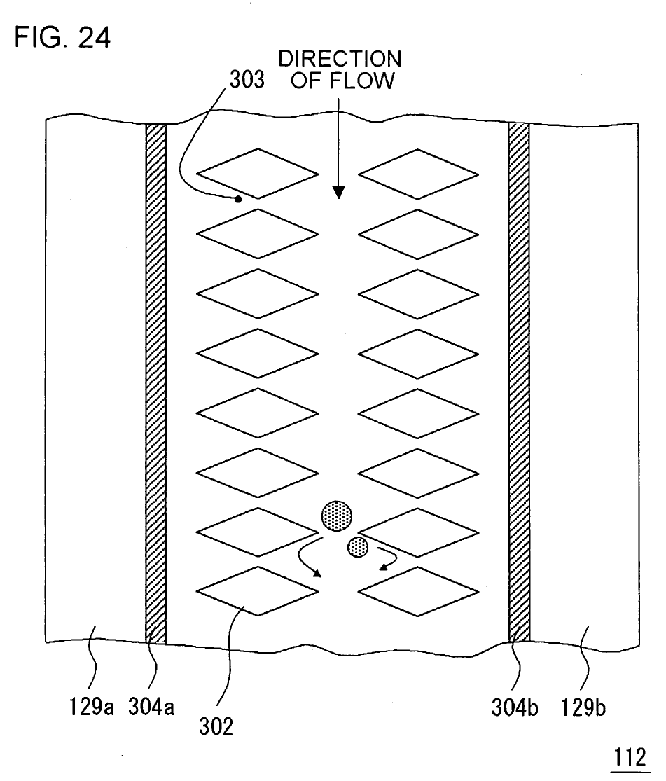

FIG. 24 is a drawing showing another example of the separation channel 112 shown in FIG. 23. The channel wall 129a and fluid channel 129b of the separation channel 112 are provided with an electrode 304a and an electrode 304b, respectively. In this embodiment, a process in which the sample is passed through the separation channel 112 under application of voltage between the fluid reservoir 101a and fluid reservoir 101b, and a process of applying voltage between the electrode 304a and electrode 304b are alternately carried out. The voltage applied herein between the electrode 304a and electrode 304b is smaller than the voltage applied between the fluid reservoir 101a and fluid reservoir 101b. The sample herein in the separation channel 112 is applied with a large force in the direction of flow, moves in the direction from the fluid reservoir 101a to the fluid reservoir 101b, and then applied with a weak-force in the direction of width of the separation channel 112. For this reason, molecules capable of entering the capture portions 300 provided to the partition wall 301a and partition wall 301b become more likely to be captured by the capture portions 300, and this is successful in further improving the separation property.

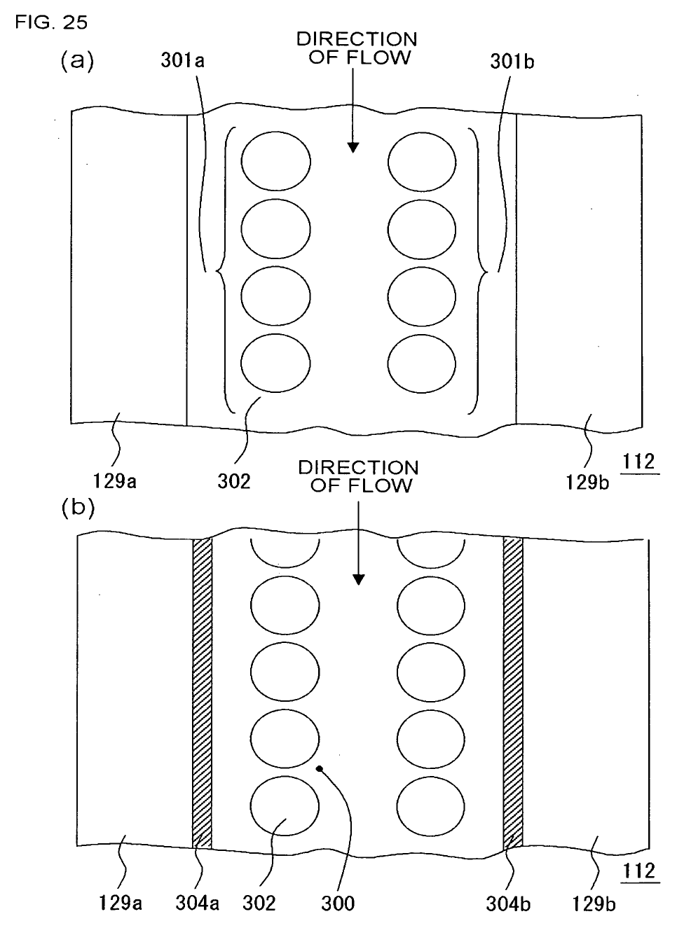

Also in this embodiment, as shown in FIG. 25, the plurality of the columnar structures 302 respectively composing the partition wall 301a and partition wall 301b in the separation channel 112 may be cylinders each having a circular bottom plane. This makes the capture portions 300 have convex curved surfaces, wherein larger-sized molecules cannot go deep into the capture portions 300, whereas only smaller-sized molecules can go deep into the capture portions 300. It is therefore made possible to effectively separate the sample containing components largely differing in their sizes. Although the columnar structures 302 were configured as the cylinders each having a circular bottom plane, they may be cylinders each having an oval bottom plane.

It is also allowable to configure the separation channel 112 so that, as shown in FIG. 25(b), the channel wall 129a and channel wall 129b of which are provided with an electrode 304a and an electrode 304b, respectively.

(Fourth Embodiment)

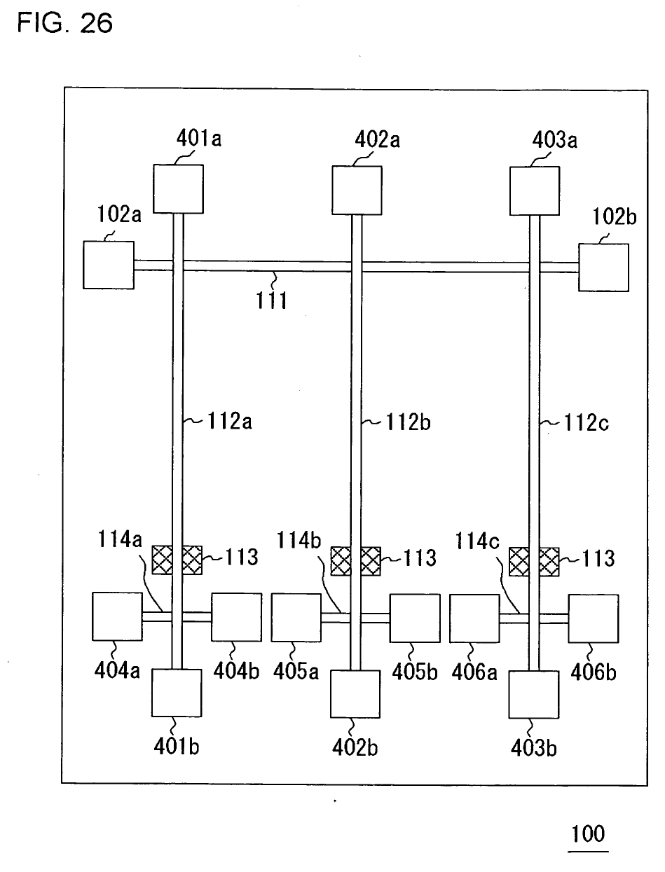

FIG. 26 is a top view showing a structure of separation apparatus 100 of a fourth embodiment of the present invention. The separation apparatus 100 of this embodiment differs from the separation apparatus 100 explained in the first to third embodiments, in view of containing a plurality of separation channels 112a, 112b and 112c. The plurality of separation channel 112a, separation channel 112b and separation channel 112c have, on both ends of which, a fluid reservoir 401a and a fluid reservoir 401b, a fluid reservoir 402a and a fluid reservoir 402b, and a fluid reservoir 403a and a fluid reservoir 403b, respectively formed thereto. The sample-charging channel 111 is formed so as to cross each of the separation channel 112a, separation channel 112b and separation channel 112c, and the sample-charging channel 111 has, formed on both ends of which, the fluid reservoir 102a and fluid reservoir 102b. There are also provided a recovery channel 114a, a recovery channel 114b, and a recovery channel 114c, so as to cross the separation channel 112a, separation channel 112b, and separation channel 112c, respectively. The recovery channel 114a, recovery channel 114b, and recovery channel 114c have, on their both ends, a fluid reservoir 404a and a fluid reservoir 404b, a fluid reservoir 405a and a fluid reservoir 405b, and a fluid reservoir 406a and a fluid reservoir 406b, respectively.

Each of the individual fluid reservoirs are provided with an electrode, with which it is made possible to apply electric field typically to each of both ends of the separation channel 112a, separation channel 112b, separation channel 112c, sample-charging channel 111, recovery channel 114a, recovery channel 114b, and recovery channel 114c. The separation channel 112a, separation channel 112b and separation channel 112c herein may be applied with different voltage values.

This configuration makes it possible to simultaneously proceed the sample separation under various conditions, and yields the effects below:

(1) In the separation of the components of the sample using the separation apparatus 100, the size of component which can most accurately be separated varies depending on the migration speed of the component during the process of separation. For example, a higher applied voltage results in a higher migration speed, so that larger-sized molecules can accurately be separated. On the contrary, a lower applied voltage results in a lower migration speed, so that smaller-sized molecules can accurately be separated. By applying different voltage values to the separation channel 112a, separation channel 112b, separation channel 112c to thereby make variation in the migration speed of the sample, it is made possible to accurately separate the components having sizes equivalent to those of the components of interest, in any of the separation channels.

(2) Mobility μ of the component of the sample can be expressed as v=Eμ (where, E is electric field, and v is migration speed of component). A more accurate mobility μ can be determined based on a slope of a line expressing relations between a plurality of peak positions of the components at a plurality of separation channel 112a, separation channel 112b or separation channel 112c and applied voltage.

Although the foregoing embodiments have explained the cases where the sample was allowed to move under application of electric field, it is also allowable to adopt a system in which the sample is moved under pressurizing. In this case, it is allowable in this embodiment to adjust the pump pressure so that different levels of pressure are applied to the plurality of separation channel 112a, separation channel 112b or separation channel 112c. Also this case is successful in obtaining effects same as those obtained when different levels of voltage were applied to the plurality of separation channel 112a, separation channel 112b or separation channel 112c. It is still also allowable to make difference in the width of these separation channel 112a, separation channel 112b or separation channel 112c, and to apply the same pressure.

The separation apparatus 100 may have a plurality of separation channels formed as being differed in the structure or size of the partition wall 301a and partition wall 301b. Also this design is successful in obtaining the above-explained effect (1).

Only three separation channels were shown herein, but the separation apparatus 100 may also be configured as comprising a larger number of separation channels. In this case, the plurality of separation channels may have a sample-charging channels used in common as shown in the drawing, but each of the separation channels may be configured as having its own sample-charging channel formed therefor. Similarly, a plurality of separation channels may have a recovery channel used in common.

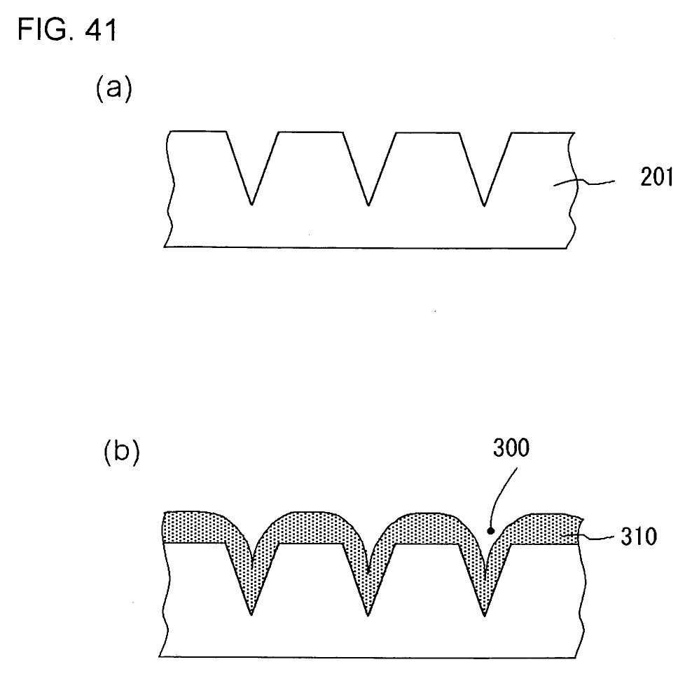

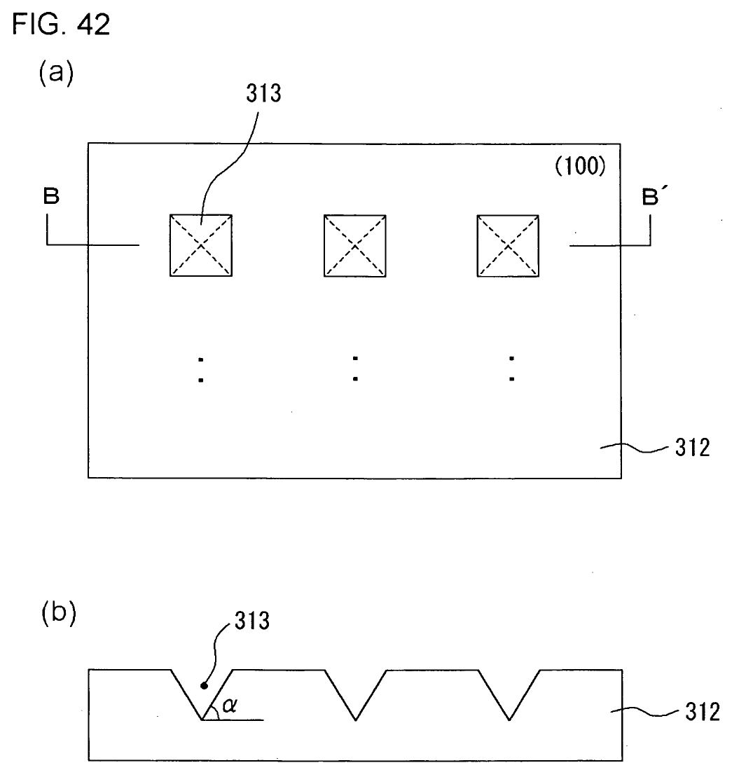

The above-described embodiment explained only a case in which the capture portions 300 are formed on the side portions of the channels, but a case in which the capture portions 300 are formed at the bottom portion of the channels is also successful in separating the components of the sample by their sizes. FIG. 41 and FIG. 42 show process steps of forming the capture portion 300 at the bottom of the channels. As shown in FIG. 41, holes having a V-shaped section are formed on the silicon substrate 201 by dry etching (FIG. 41(a)), and the top surface of the silicon substrate 201 is then oxidized to the oxide film 310 (FIG. 41(b)). This is successful in forming the capture portions 300 at the bottom of the channels.

It is also allowable, as shown in FIG. 42, to wet-etch a silicon substrate 312 having a surface of (100) plane orientation, to thereby form square-pyramid-shaped grooves 313 having side walls inclined with respect to the surface (FIG. 42(a)). FIG. 42(b) is a sectional view taken along line B-B′ in FIG. 42(a). Angle α is adjusted to approximately 54.70°. Similarly to the case shown in FIG. 41, the succeeding oxidization of the top surface of the silicon substrate 312 can form the capture portions 300 at the bottom of the channels (not shown).

(Fifth Embodiment)

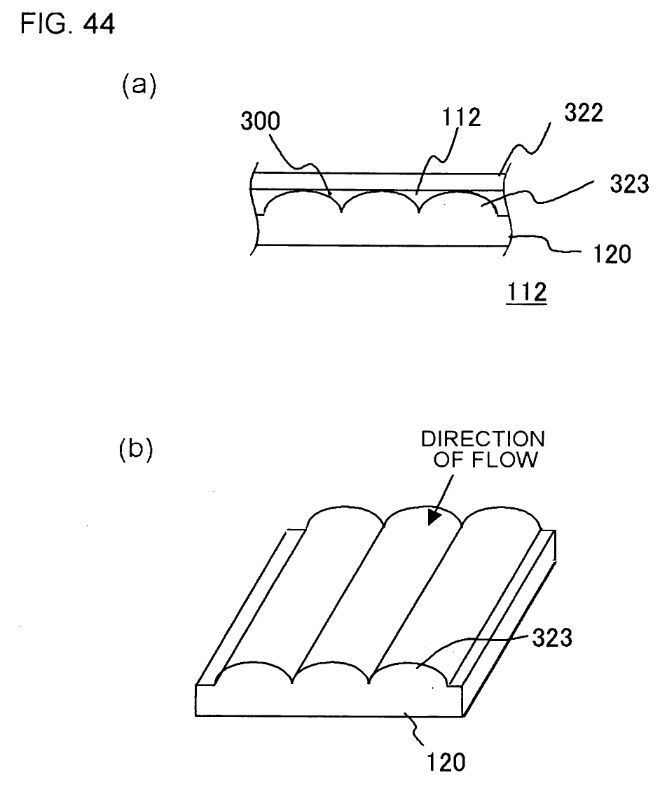

FIG. 44(a) and FIG. 44(b) are drawings detailing a structure of the separation channel 112 of this embodiment. FIG. 44(a) is a sectional view of the separation channel 112. FIG. 44(b) is a perspective view showing a configuration of the substrate 120 composing the separation channel 112 shown in FIG. 44(a). A general configuration of the separation apparatus of this embodiment is similar to that of the separation apparatus 100 shown in FIG. 1.

In FIG. 44(a), the groove-formed separation channel 112 formed on the substrate 120 have, on the bottom plane thereof, a plurality of hog-backed projections 323 formed in parallel to each other in the direction of extension of the separation channel 112. Each of the projections 323 has a convex curved surface. A flat-plate-type cover 322 is provided over the separation channel 112.

In the separation channel 112 of this embodiment, the capture portions 300, which extend in the longitudinal direction of the separation channel 112, are formed between the projection 323 having the convex curved surface and the cover 322. As shown in FIG. 44(a) and FIG. 44(b), each of the capture portions 300 is formed as a gap gradually narrowed in the width in the depth-wise direction thereof towards the contact portion between the cover 322 and projection 323.

Sizes of the projection 323 may be selected depending on species of the sample, wherein the height and radius thereof may typically be adjusted to 1 μm to 100 μm or around. The projections 323 may be disposed so as to keep a distance of 2 to 200 μm or around between the center lines of the projections 323.

In the configuration shown in FIG. 44(a) and FIG. 44(b), components of the sample move through the separation channel 112 formed by two adjacent projections 323 and the cover 322, in the direction indicated by the arrow in FIG. 44(b). Driving force of the movement may typically be electrophoresis, similarly to as in other above-described embodiments. Because molecules which can go deep into the capture portions 300 take a longer time to come out from the gap than molecules which cannot go deep, based on the principle of size exclusion chromatography, larger molecules therefore flow rapidly and smaller molecules flow slowly, and this realizes molecular-size-dependent separation.

In this embodiment, thermoplastic and highly insulating materials can appropriately be used as materials composing the substrate. Specific examples preferably used of which include glass, polystyrene (PS), polyethylene terephthalate (PET) and polymethyl methacrylate (PMMA). The cover 322 may be composed of the same material with the substrate 120.

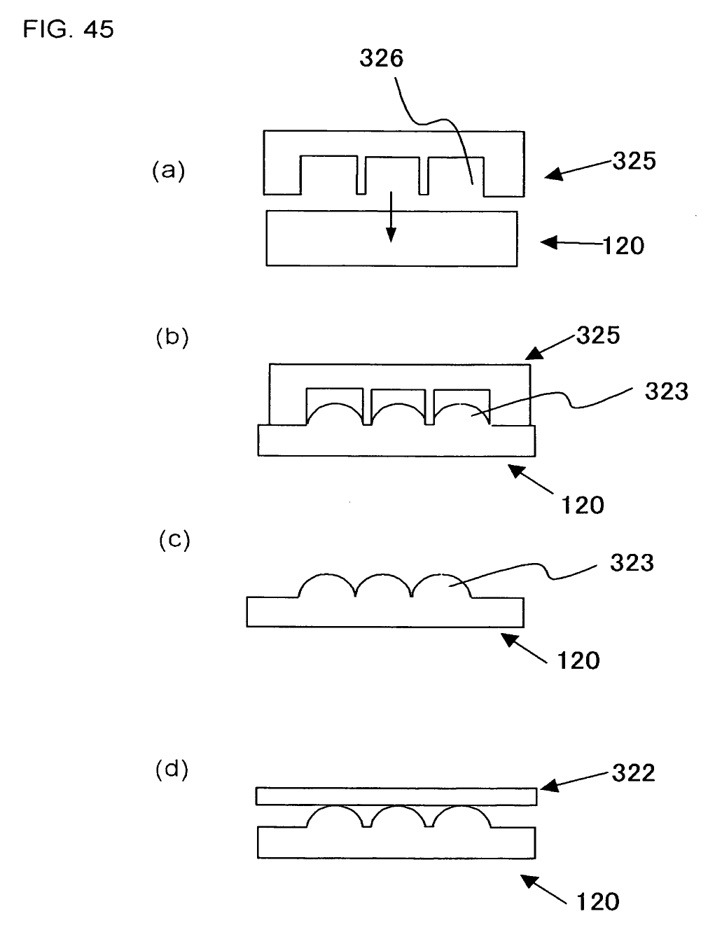

FIG. 45(a) to FIG. 45(d) are step-wise sectional views showing procedures of fabricating the separation preferably 112 shown in FIG. 44(a) and FIG. 44(b). In FIG. 45(a) to FIG. 45(d), a die 325 forming the projections 323 on the substrate 120 is used (FIG. 45(a)). The die 325 has groove-formed concaves 326 each having a width corresponded to the width of each projection 323. This sort of die 325 can be obtained typically by gas etching or wet etching of the silicon substrate in the longitudinal direction of the preferably. It is also allowable to use a nickel plate having a geometry of the die 325 transferred thereon by the electroforming process. The concaves 326 may not always necessarily have a geometry corresponded to the hog-backed projections, but may be rectangular grooves, or mesa-formed groove produced by anisotropic etching of the Si(100) substrate.

The die 325 and substrate 120 are heated to a temperature around the glass transition point of the material composing the substrate 120, and the substrate 120 and the die 325 are pressed with each other (FIG. 45(b)). The substrate 120 herein go, while deforming itself, into the inner portion of the concaves 326 carved in the die 325, and thereby the projections 323 each having the convex curved surface are formed. Height of the projections 323 or geometry of the convex curved surface herein may be controlled by pressure or temperature during the pressing. The narrowness and degree of narrowing of the capture portions 300 formed by the cover 322 and projections 323 are controllable by the degree of adjustment, and the capture portions 300 can be fabricated as being adapted typically to sizes of components contained in the sample to be separated.

Next, the die 325 and substrate 120 are cooled, and the die 325 is released from the substrate 120 (FIG. 45(c)). The released die 325 is used for the next pressing. The cover 322 is placed on the substrate 120 having the projections 323 thus obtained after the releasing (FIG. 45(d)). In this way, the separation channel 112 as shown in FIG. 44(a) and FIG. 44(b) is formed.

In FIG. 45(d), the separation channel 112 of this embodiment is obtained by placing the flat-plate-type cover 322 on the top ends of the projections 323. An exemplary method of placing the cover 322 on the projections 323 can be realized by providing appropriate spacers between the substrate 120 and cover 322, while bringing the cover 322 into contact with the top ends of the projections 323, and by fixing, through adhesion, the spacers to the substrate 120 and cover 322. It is also allowable to appropriately heating the cover 322 or substrate 120, and to fuse the one with another. It is also allowable to spray a trace amount of a solvent, which is acetone for example, capable of dissolving a material composing the cover 322, over the adhesion surface of the cover 322, and to press it to the upper portion of the projections 323. The cover 322 can be fixed on the projections 323 still also by coating a trace amount of an adhesive on the surface of the cover 322, and to similarly adhere it to the upper ends of the projections 323.

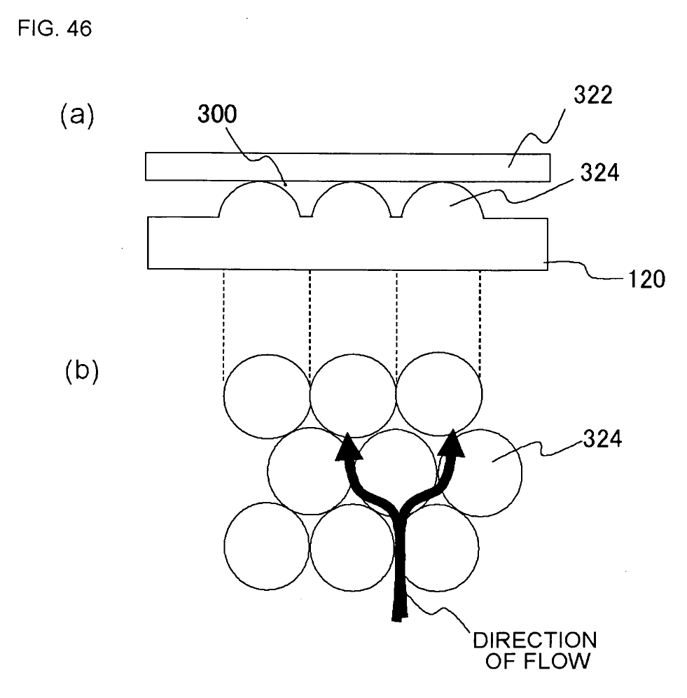

FIG. 46(a) and FIG. 46(b) are drawings showing another example of the projection. FIG. 46(a) is a sectional view of the separation channel 112. FIG. 46(b) is the top view. It is to be noted that the cover 322 is not shown in FIG. 46(b).

In FIG. 46(a) and FIG. 46(b), a plurality of hemispherical projections 324 are formed on the bottom surface of the separation channel 112. For the case where the projections 323 are formed in the longitudinal direction of the separation channel as shown in FIG. 44(a) and FIG. 44(b), the components of the sample cannot migrate from one channel to other channel formed between the adjacent projections 323. This may cause clogging of the sample in the capture portions 300. In contrast to this, the projections 324 having a geometry shown in FIG. 46(a) and FIG. 46(b) are configured so as to successfully suppress the clogging. As shown in FIG. 46(b), even if the components of the sample should clog in one direction, the integration of the projections 324, each having a circular bottom plane, can allow the sample to flow in other direction as indicated by the arrow in the drawing, and can reduce the clogging of the components.

The projections 324 are formed to have a hemispherical geometry, wherein the height and radius thereof may typically be adjusted to 1 μm to 100 μm or around. The projections 324 may be disposed so as to keep a distance of 2 to 200 μm or around between the center lines of the projections 323. Materials and a method used for fabricating the separation channel 112 may be similar to those for the case where the projections 323 are formed, except that geometry of the die differs. Each of the projections 324 may have an oval geometry of the bottom plane.

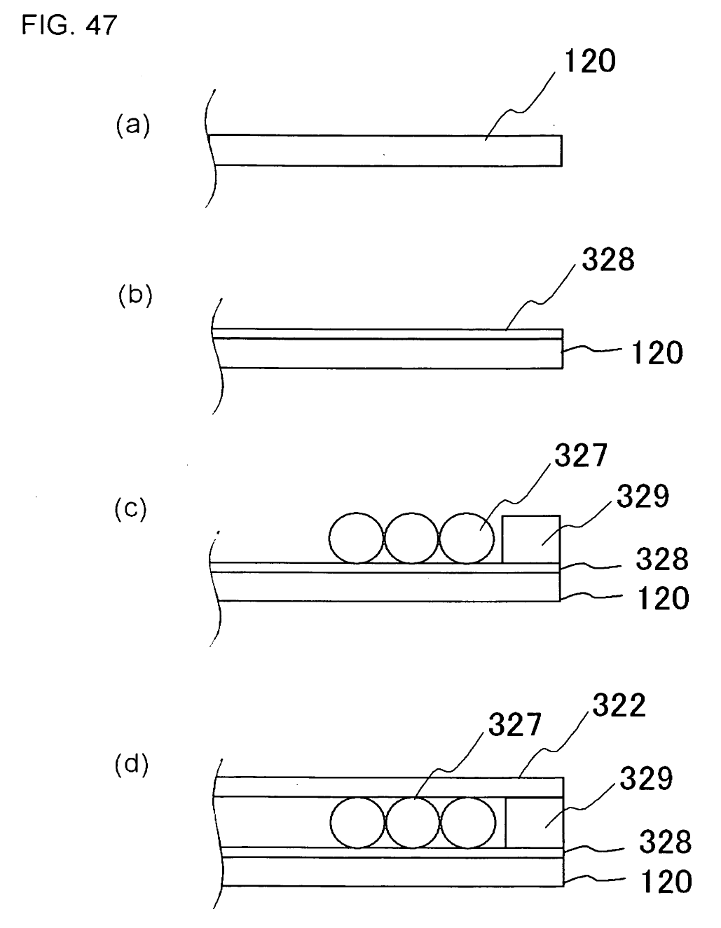

It is still also allowable to form the separation channel 112 in which the projections 324 have a spherical geometry. FIG. 47(a) to FIG. 47(d) are step-wise sectional views showing procedures of fabricating the separation channel 112 in this case.

Any of the above-described materials is used for the substrate 120 (FIG. 47(a)). An adhesive 328 containing an acrylic resin or the like as a base is formed on the substrate 120 to a thickness of approximately 1 μm or below (FIG. 47(b)). On the adhesive 328, stopper plates 329 sealing the side edges of the separation channel 112 are adhered along the longitudinal direction of the separation channel 112. A material composing the stopper plates 329 may be glass or acrylic resin, for example. Next, beads 327 having a radius of several micrometers to 100 μm or around, made of glass, acrylic resin or the like, are scattered and are fixed to the inner portion of the separation channel 112 (FIG. 47(c)). The cover 322 is finally fixed similarly to as described in the above (FIG. 47(d)).

By using the beads 327 as the projections, there are formed the capture portions 300 gradually narrowed towards the direction departing from the separation channel 112, in the vicinity of the contact portions between the beads 327 and substrate 120, and between the beads 327 and cover 322. This configuration is also successful in realizing size exclusion chromatography.

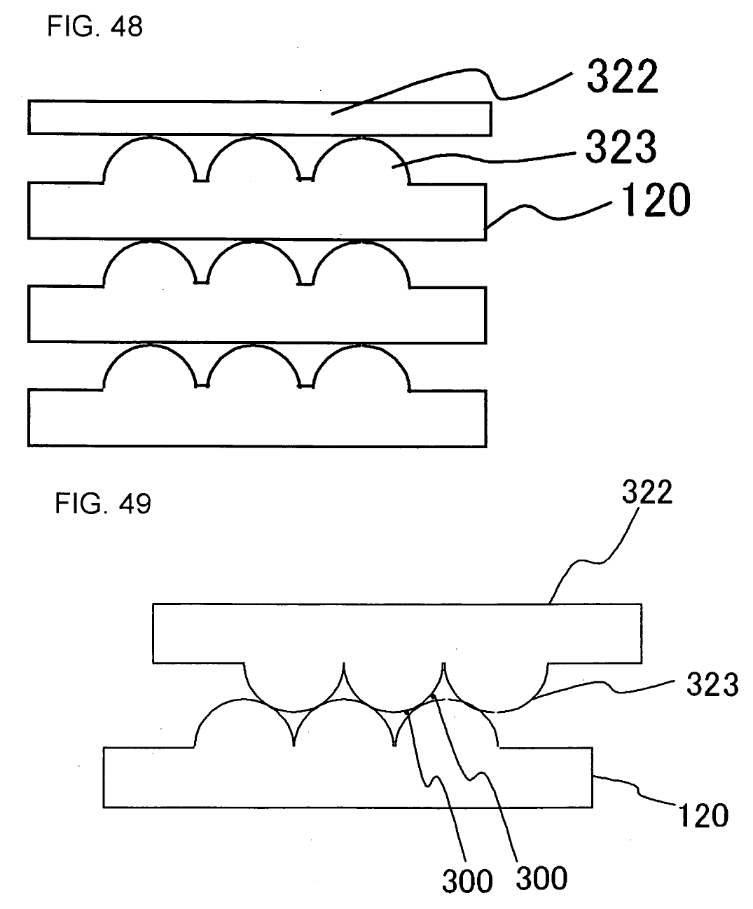

It is also allowable, as shown in FIG. 48, to stack the substrates 120 each having the projections having the above-described geometry, to thereby make a vertical parallel configuration of the separation channel.

According to the configuration of this embodiment, it is made possible to fabricate the separation channel by an inexpensive simple method, without using any expensive process apparatuses. This is successful in obtaining, only with a lower cost, the separation channel 112 having the capture portions 300 formed with a sufficiently narrow width suitable for separating small biological molecules such as DNA and protein.

It is still also allowable to use a substrate having the projections formed thereon as the cover 322, in place of the flat-plate-type cover 322. Geometry of the projections formed on the cover 322 may typically be the above-described hog-backed ones or hemispherical ones. FIG. 49 shows a stacked state of the substrate having the projections 323 as shown in FIG. 44(a), and the cover 322 having, similarly to the substrate 120, a plurality of projections 323 each having a convex curved surface formed thereon in a parallel manner.

In FIG. 49, the cover 322 is disposed on the substrate 120 so that the top portions of the projections 323 on the substrate 120, and the top portions of the projections 323 formed on the cover 322 are staggered at desired positions. This way of staggering by an appropriate amount, rather than abutting the top portions of the projections 323, makes it possible to desirably adjust the geometry of the capture portions 300, and to carry out component-adaptive separation of the sample. This is successful in improving the separation effect.

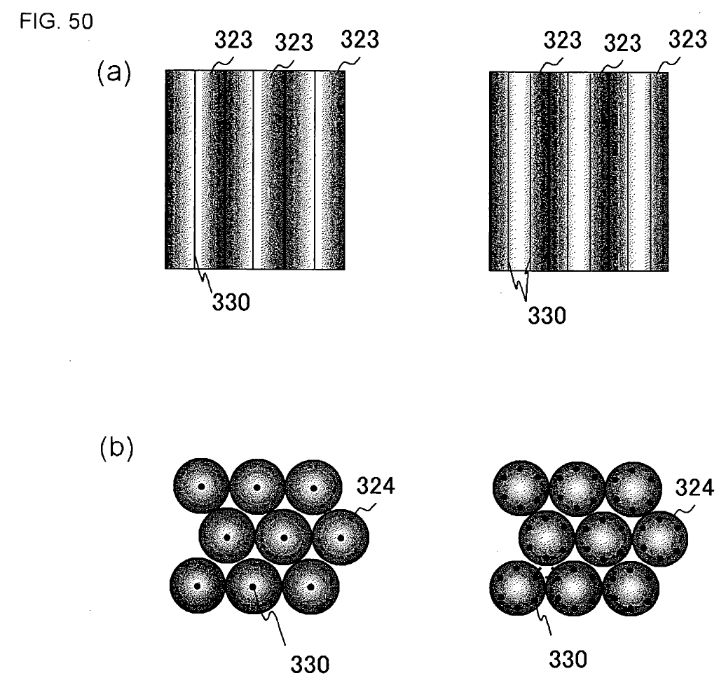

The stacking of the substrate 120 and cover 322 so as to stagger the top portions of the projections 323 also makes it possible to increase the number of capture portions 300 formed in the separation channel 112 by approximately several number of times. This will be explained referring to FIG. 50(a) and FIG. 50(b).

FIG. 50(a) and FIG. 50(b) are top views of the projections formed on the substrate 120 in the separation channel 112. FIG. 50(a) shows an exemplary case of the separation channel 112 having the hog-backed projections 323 formed therein. FIG. 50(b) shows an exemplary case where the semispherical projections 324 are integrated. Brighter portion of the projections 323 or projections 324 expressed in these drawings are more largely protruded from the bottom surface of the substrate 120. Contact points 330 expressed by black dots in the drawings indicate positions where the projections come into contact with the cover 322. In each of FIG. 50(a) and FIG. 50(b), the left drawing indicates positions of the contact portions 330 formed when the top portions of the projections 323 or the projections 324 are brought into contact with the top portions of the projections 323 or the projections 324 formed on the cover 322, respectively. Each of the right drawings indicates positions of the contact portions 330 formed when the top portions of the substrate 120 and top portions of the cover 322 are staggered.

As shown in the right drawing of FIG. 50(a), the number of portions which can serve as the capture portions 300 is doubled by the stacking of the substrate 120 and cover 322 while staggering the top portions. A triangle drawn by a black broken line in the right drawing of FIG. 50(b) indicates a connection of the contact portions 330 of three projections 324 on the substrate 120 side, brought into contact with one semispherical projection 324 formed on the cover 322. It is known in this case that the number of portions which can serve as the capture portions 300 is increased by six times.

In this embodiment, the capture portions 300, which are the portions narrowed in the width in the depth-wise direction of the separation channel 112 are thus formed on wall portions which configure the side surfaces of the separation channel 112. The wall portions referred herein may be the side walls of the separation channel 112, or may be the projections projected out from the bottom surface of the substrate 120 towards the center of the separation channel. Also this sort of configuration can successfully capture small molecules contained in the sample into the capture portions 300, and makes it possible to stably separate the components of the sample.

In this embodiment, the separation channel 112 can be fabricated without using costly process steps such as electron beam lithography, gas etching and thermal oxidation. The separation channel 112 of this embodiment can be fabricated by inexpensive process steps such as wet etching, pressing and adhesion, ensuring a stable fabrication of the separation channel 112 with a low cost of fabrication.

Although the foregoing paragraphs have described the exemplary case where the projections formed on the substrate 120 and projections formed on the cover 322 have the same geometry, the geometry of the projections formed on the substrate 120 and projections formed on the cover 322 are not limited to being the same, but may appropriately be selected depending typically on sizes of components to be separated. The projection 323 or projection 324 can be formed on the cover 322, typically by the method explained referring to FIG. 45(a) to FIG. 45(d).

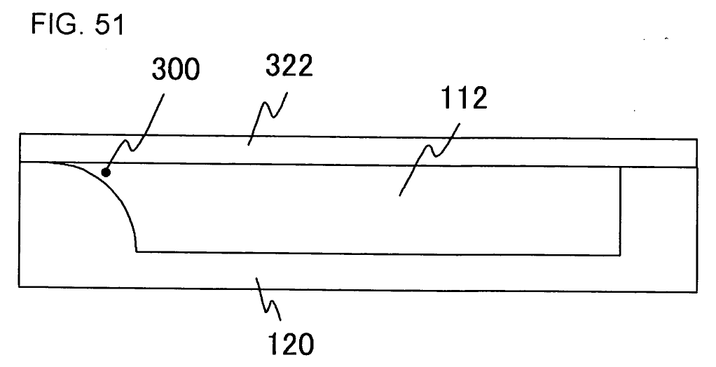

The forgoing paragraphs have described the example in which a plurality of capture potions 300 were provided in the separation channel 112, but provision of only a single capture portion 300 provided to the capture portion 300 is also allowable. FIG. 51 is a sectional view showing a configuration of the separation channel 112 having only a single capture portion 300 provided thereto. As shown in FIG. 51, one of the side wall of the separation channel 112 is given as a convex curved surface, and the capture portion 300 is formed in a gap between the substrate 120 and cover 322 so as to extend in the longitudinal direction of the separation channel 112. This configuration is successful in stably separate specific components of the sample only with a further simpler structure.

<Analytical System>

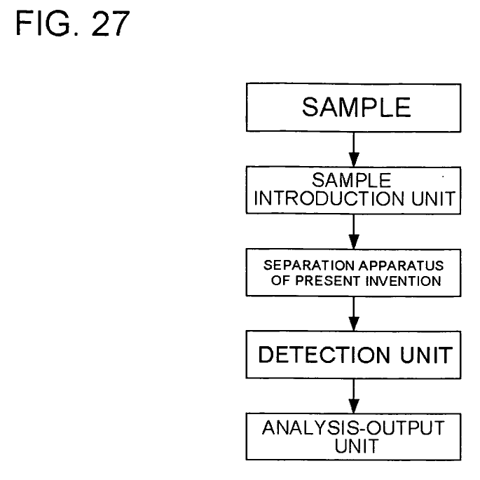

Next, a configuration of an analytical system comprising the separation apparatus 100 explained in the first to fifth embodiments, referring to FIG. 27. As shown in FIG. 27, the separation system comprises an analytical apparatus equipped with a sample introduction unit, a detection unit and an analysis-output unit; and a separation apparatus according to any one of the above-described embodiments incorporated therein. A sample to be analyzed is introduced into the sample introduction unit of the analyzer, and separated into components by the separation apparatus of the present invention. Thus-separated components are detected by the detection unit. Detection results thus obtained are analyzed by the analysis-output unit, and analyzed data is output.

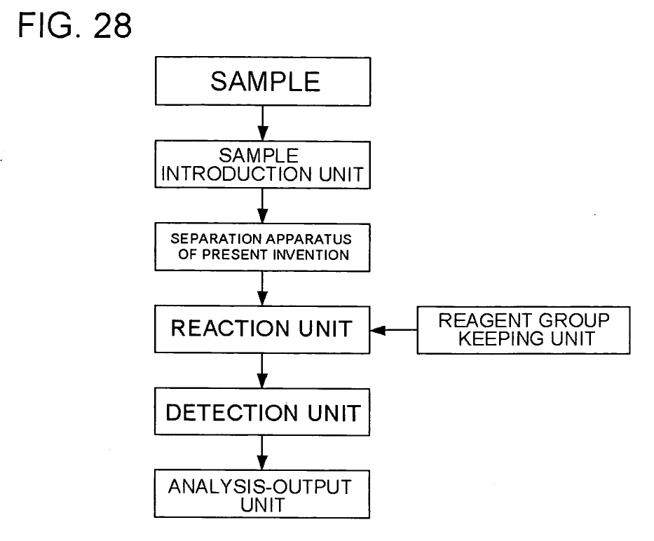

The analyzer may further comprise a reaction unit and a reagent group keeping unit, as shown in FIG. 28. The individual components of the sample separated by separation apparatus of the present invention are sent to the reaction unit, and mixed therein with a coloring reagent or the like. Results of the reaction in the reaction unit are detected by the detection unit. Thus-obtained results of detection are analyzed by the analysis-output unit, and the analyzed data is output. The detection and measurement unit are omissible if the reaction in the reaction unit is, for example, a coloring reaction or luminescent reaction, and therefore can visually be detected and measured.

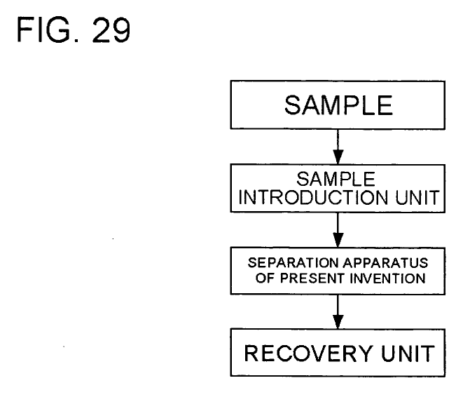

The above-described analyzer can include, as shown in FIG. 29, a recovery unit in place of the detection unit and analysis-output unit. The individual components in a regent separated by the separation apparatus of the present invention are recovered by the recovery unit.

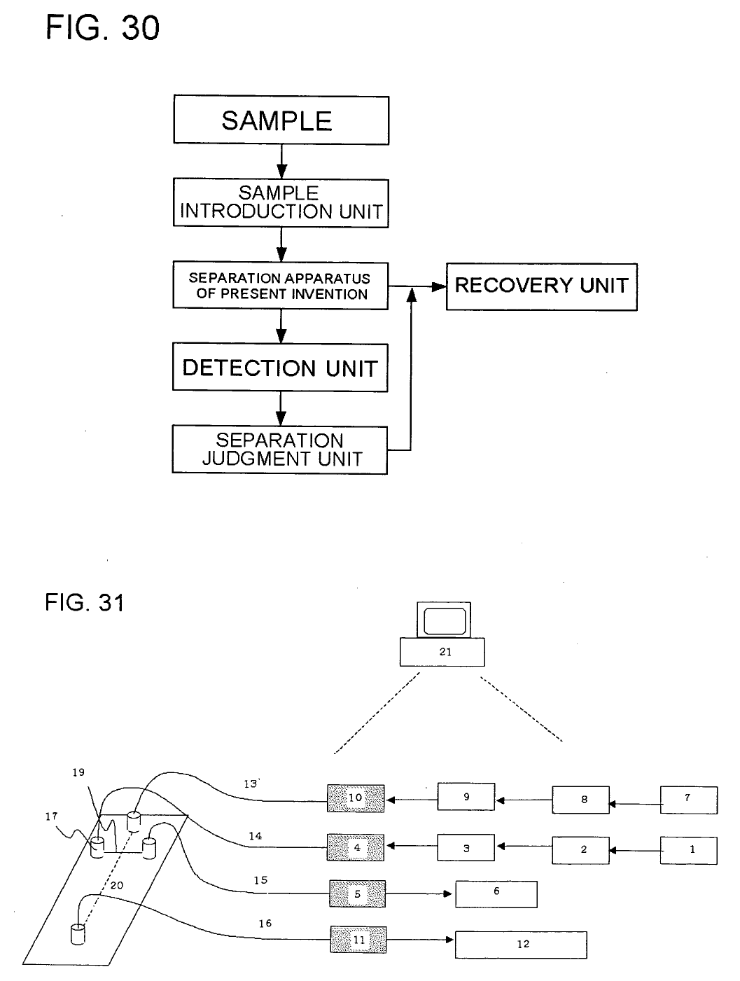

It is still also allowable for the analyzer to include, typically as shown in FIG. 30, a separation judgment unit and the recovery unit in place of the analysis-output unit. The individual components of a sample separated by the separation apparatus of the present invention are detected by the detection unit, and based on detected results, the separation state and target components are identified by the separation judgment unit. Results of the judgment made by the separation judgment unit are transmitted to the recovery unit, and the recovery unit recovers the target components.

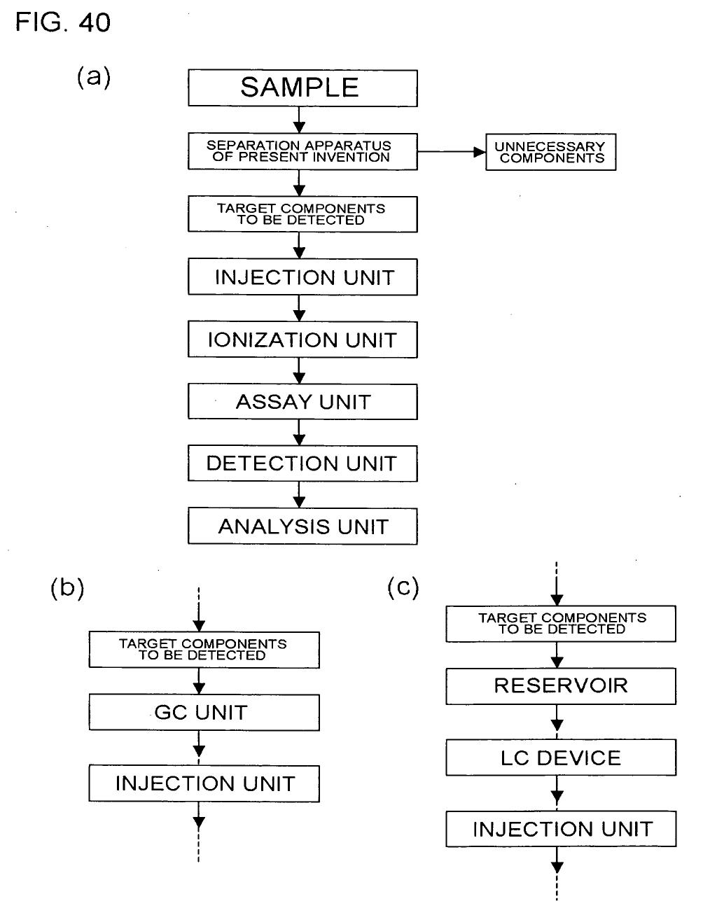

The analyzer can also be configured so as to function as a mass analyzer system, as shown in FIG. 40. FIG. 40(a) is a drawing showing a basic configuration of a mass analyzer system (MS analyzer) of this embodiment. The analytical system of this embodiment is configured so that any one of the separation apparatuses of the above-described embodiments is incorporated into an analyzer which comprises an injection unit, ionization unit, assay unit, detection unit and analysis unit. A sample to be analyzed is introduced into the separation apparatus, and is separated into components to be detected and unnecessary components. The components to be detected are then introduced into the injection unit of the analyzer, sent to the ionization unit, and ionized. The ionized components to be detected are sequentially analyzed and detected by the assay unit and detection unit. Thus obtained data are analyzed by the analysis unit, and the analyzed data are output.

The analytical system can also be configured as comprising a GC unit to thereby configure a GC-MS analyzer, as shown in FIG. 40(b). The analytical system can still also be configured as comprising a reservoir and an LC device to thereby configure an LC-MS analyzer, as shown in FIG. 40(c). The reservoir is not always necessary, although the reservoir is provided in FIG. 40(c) for the purpose of supplying a relatively large amount of components to be detected to the LC device. Although FIG. 40(b) shows no reservoir, the reservoir may be provided in the preceding stage of the GC unit.

The sample herein is not specifically limited, and can be exemplified by blood, tissue extract and so forth.

All constituents described in the above, or a part of the constituents such as the sample introduction region, separation apparatus of the present invention, reaction unit, reagent keeping unit and recovery unit, may be provided on an analytical chip.

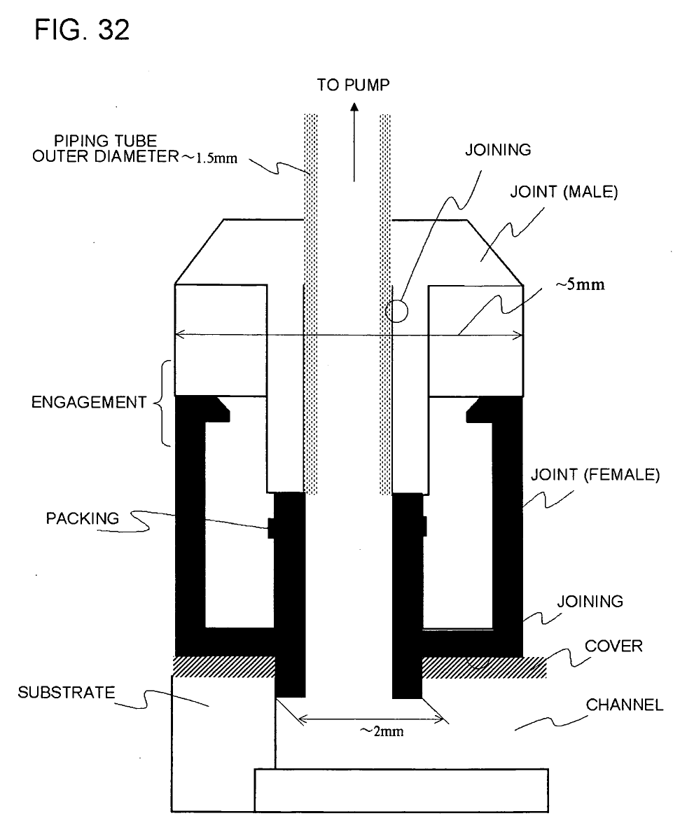

Although the first to fifth embodiments have described the separation apparatuses 100 allowing the sample to move under applied electric field, it is also allowable to adopt a system based on pressure application in place of electric field application. FIG. 31 shows an exemplary apparatus of this type. The fluid reservoir portions disposed at the ends of the sample-charging channel and separation channel on the separation chip have female joints fixed thereto. Each of the female joints is connected to a male joint having one of hollow tubes 13, 14, 15 and 16. The reason why the joints are used is to avoid liquid leakage. A specific structure of the joints are such as those shown in as FIG. 32.

The individual tubes connected to the male joints are joined with solenoid valves 10, 4, 5 and 11, respectively. The solenoid valve 10 is supplied with a buffer from a fluid reservoir 7 through a separation pump 8 and a constant-rate injector 9. The solenoid valve 4 is supplied with a sample from a sample reservoir 1 through an charge pump 2 and a constant-rate injector 3. The solenoid valve 5 is supplied with the sample sent through a sample-charging channel 19, and the sample is led to a waste fluid reservoir 6. The solenoid valve 11 is supplied with the sample separated through the separation channel 20, and the sample is recovered by an automatic sampler 12.

A control unit 21 controls operation timings of the solenoid valves 4, 5, 10 and 11, separation pump 8, charge pump 2, constant-rate injector 9, and constant-rate injector 3.

Procedures for the separation and recovery using this device are as the following. First, the solenoid valves 10 and solenoid valve 11 are closed. This successfully prevents the sample from going from the sample-charging channel 19 into the separation channel 20. Next, the solenoid valve 4 and solenoid valve 5 are opened. The sample is put in the sample reservoir 1.

Next, the sample is pressurized using the charge pump 2, and then led through the constant-rate injector 3, solenoid valve 4 and tube 14 to the sample-charging channel 19. The sample leaked via the sample-charging channel 19 is led through the tube 15 and solenoid valve 5 to the waste fluid reservoir 6.

After the sample is filled in the sample-charging channel 19, the solenoid valve 4 and solenoid valve 5 are closed, and the solenoid valve 10 and solenoid valve 11 are opened. Next, the buffer is pressurized using the separation pump 8, and the sample is lead through the constant-rate injector 9, solenoid valve 10 and tube 13 to the separation channel 20. The separation is now ready to start. Separated substances comes out together with the buffer from the front of the separation channel 20 through the tube 16 and solenoid valve 11, and the sample is periodically collected by the automatic sampler 12.

The sample separation is thus proceeded by these procedures. This device, using pressure as an the external force for allowing the sample to migrate, demands only a relatively simple external force imposing unit, and is therefore advantageous in view of reducing production cost and downsizing of the device.

It is also allowable for the separation apparatus 100 shown in FIG. 1 to adopt a system in which the sample is allowed to migrate with the aid of capillary phenomenon. There is no need of applying any external force such as electric power nor pressure, so that no drive energy is necessary.

### EXAMPLE 1

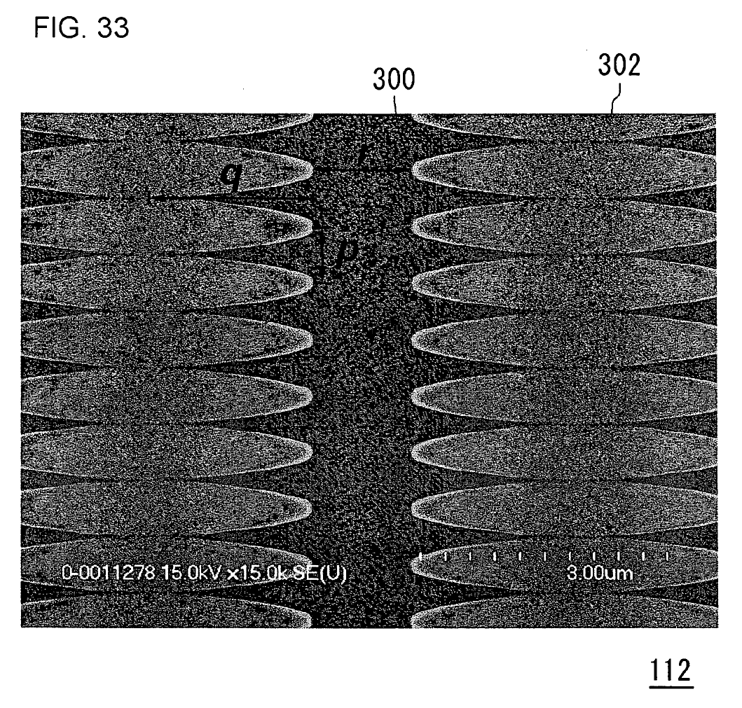

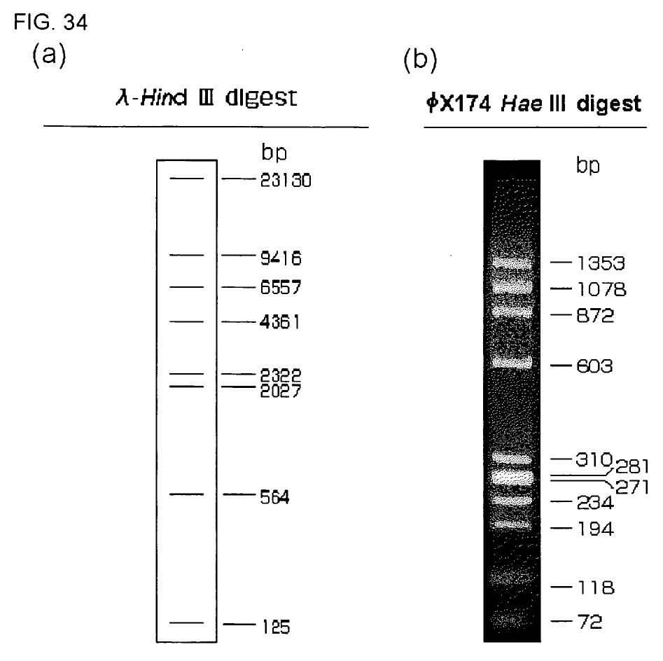

Similarly to as explained referring to FIG. 6 and FIG. 7, the separation apparatus 100 shown in FIG. 1 and FIG. 4 was fabricated. FIG. 33 is a top view of the separation channel 112 of the separation apparatus 100, shown as an electron microphotograph. Distance p herein was approximately 700 nm, distance q was approximately 2 μm, and distance r was approximately 1.2 μm. Molecular weight markers were separated using the separation apparatus 100 comprising thus-composed separation channel 112. The molecular weight markers employed herein are Lambda DNA-Hind III Digest (product of Takara Bio Inc.) and phiX-174 RF DNA-Hae III Digest (product of Takara Bio Inc.). Lambda DNA-Hind III Digest and phiX-174 RFDNA-Hae III Digest have fragments shown in FIG. 34(a) and FIG. 34(b), respectively.

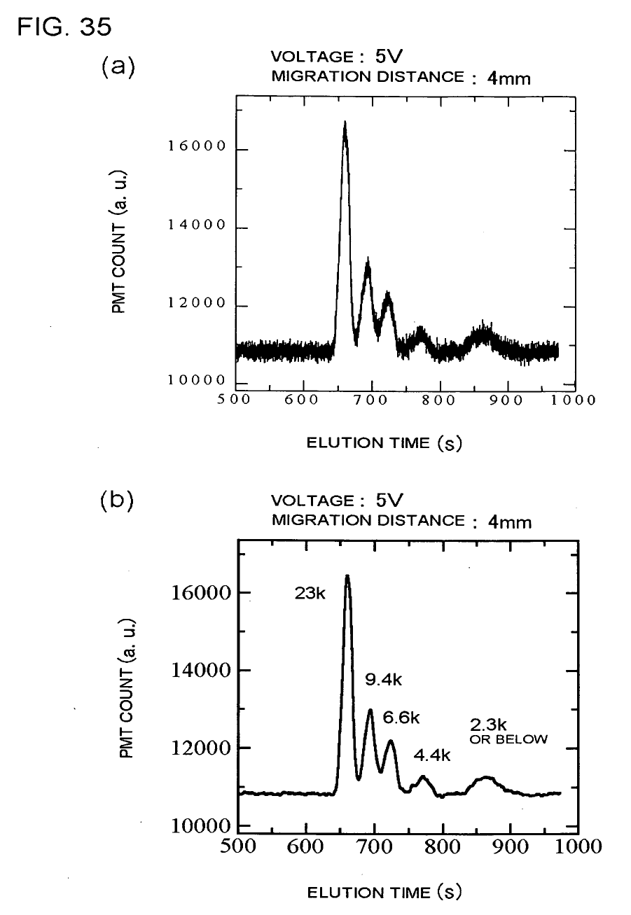

FIG. 35 shows a result of separation obtained when Lambda DNA-Hind III Digest was used as the molecular weight marker. FIG. 35(b) was obtained by smoothing the data shown in FIG. 35(a). As shown in FIG. 35(b), peaks were detected at 23 kbp, 9.4 kbp, 6.6 kbp, 4.4 kbp, and 2.3 kbp or below.

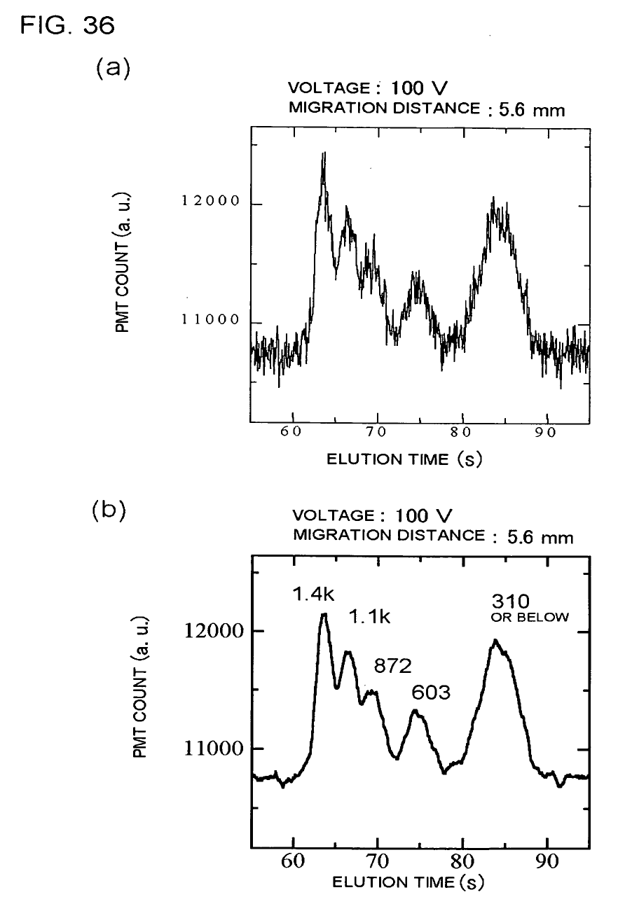

FIG. 36 shows a result of separation obtained when phiX-174 RF DNA-Hae III Digest was used as the molecular weight marker. FIG. 36(b) was obtained by smoothing the data shown in FIG. 36(a). As shown in FIG. 36(b), peaks were detected at 1.4 kbp, 1.1 kbp, 872 bp, 603 bp, and 310 bp or below.

(Reference Examples)

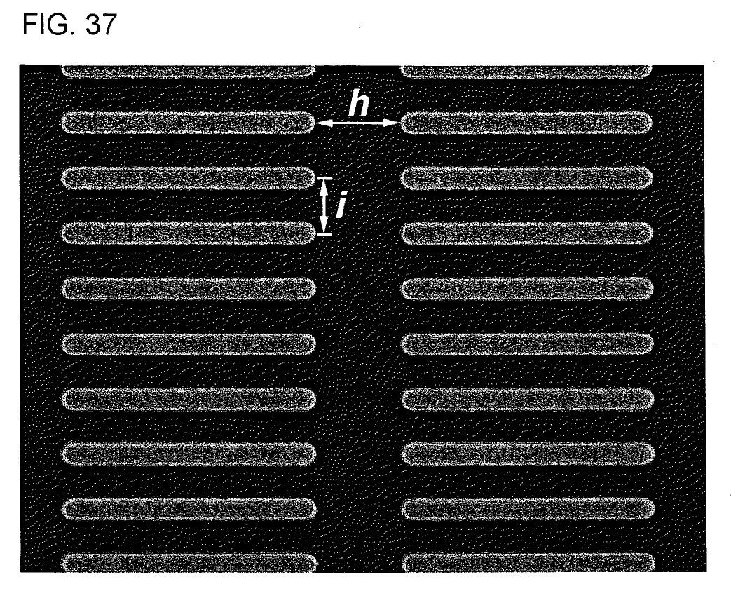

As reference examples, Lambda DNA-Hind III Digest and phiX-174 RF DNA-Hae III Digest were separated using a separation apparatus including a separation channel having a plurality of columnar structures as shown in FIG. 37. Distance h herein is approximately 1.1 μm, and distance i is approximately 400 nm. The plurality of columnar structures in these examples are arranges at regular intervals.

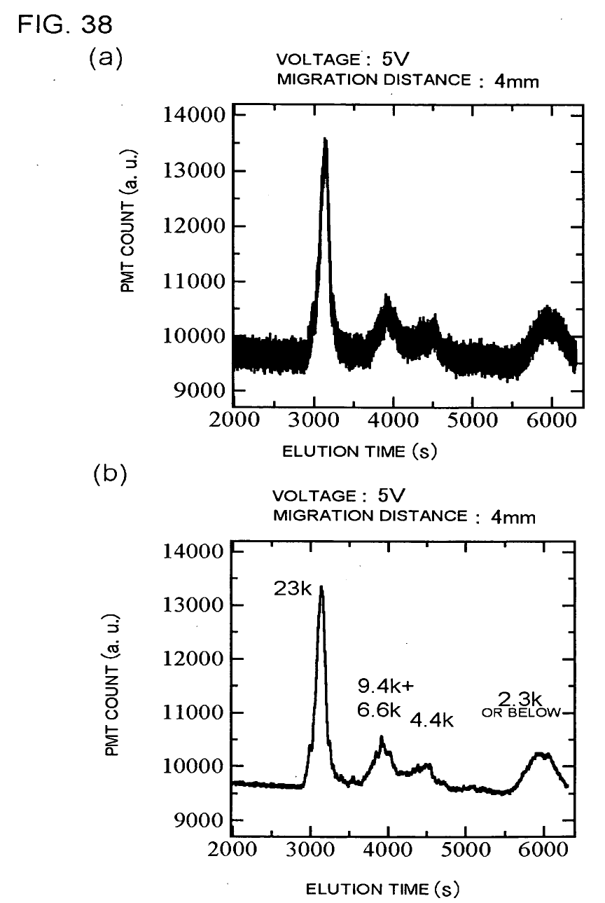

FIG. 38 shows a result of separation obtained when Lambda DNA-Hind III Digest was used as the molecular weight marker. FIG. 38(b) was obtained by smoothing the data shown in FIG. 38(a). As shown in FIG. 38(b), peaks were detected at 23 kbp, 9.4 to 6.6 kbp, 4.4 kbp, and 2.3 kbp or below.

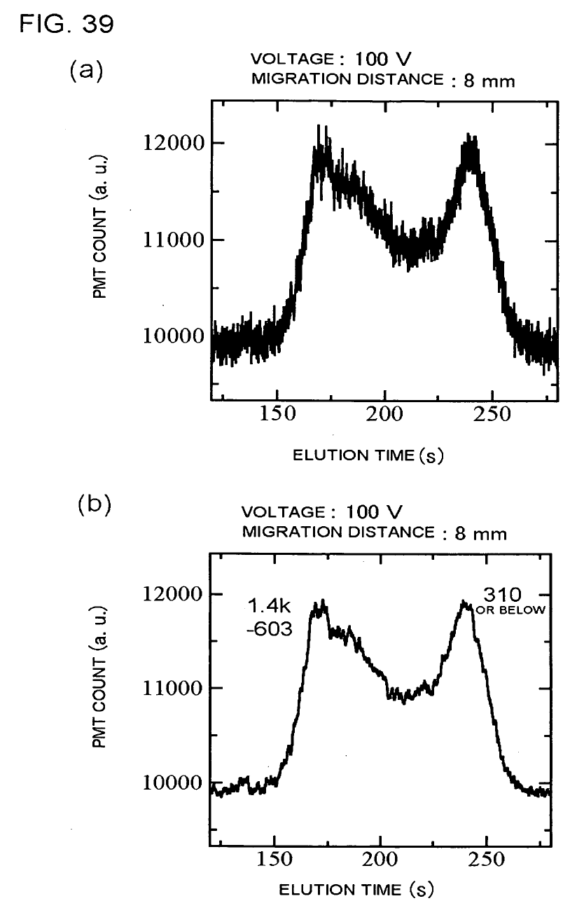

FIG. 39 shows a result of separation obtained when phiX-174 RF DNA-Hae III Digest was used as the molecular weight marker. FIG. 39(b) was obtained by smoothing the data shown in FIG. 39(a). As shown in FIG. 39(b), the peak ranging from 1.4 kbp to 603 bp was found only as a broad peak, indicating an unsuccessful separation.

Comparison of FIG. 35 expressing the Example and FIG. 38 expressing the Reference Example, both using Lambda DNA-Hind III Digest, revealed that the separation apparatus 100 of the Example was successful in clearly separating the peaks at 23 kbp, 9.4 kbp, 6.6 kbp, 4.4 kbp and 2.3 kbp, but the separation apparatus of the Reference Example broadened the peaks at 9.4 kbp and 6.6 kbp, indicating an unsuccessful separation. Similar comparison of FIG. 36 expressing the Example and FIG. 39 expressing the Reference Example, both using phiX-174 RF DNA-Hae III Digest, revealed that the separation apparatus 100 of the Example was successful in clearly separating the peaks 1.4 kbp, 1.1 kbp, 872 bp, 603 bp and 310 bp or below, but the separation apparatus of the Reference Example broadened the peaks at 1.4 kbp to 603 bp, indicating an unsuccessful separation.

### EXAMPLE 2

In this Example, a wedge-formed chip was fabricated and used for separation of proteins. Similarly to as explained referring to FIG. 6 and FIG. 7, the separation apparatus 100 shown in FIG. 1 and FIG. 4 was fabricated. As for the sizes shown in FIG. 33, distance p was approximately 600 nm, distance q was approximately 1.5 μm, and distance r was approximately 1.2 μm. Protein samples were separated and detected using the separation apparatus 100 comprising thus-composed separation channel 112.

Two protein samples (97 kD and 31 kD) were denatured by boiling in an SDS-containing aqueous solution at 100° C. for 7 minutes, and then rapidly cooled on ice. Next the protein samples were added with an one-thousandth amount of fluorescent dye SYPRO ORANGE (product of Molecular Probes, Inc.) for dyeing for one hour. Next, a TBL buffer (0.1 M Tris+0.25 M boric acid+0.6% Lipidure HM (product of NOF Corporation) was coated over the entire channel, and a mixture of the dyed protein samples and TBL buffer was separated. The separation was proceeded under an applied potential 120 V). The separated proteins were detected by measuring fluorescent intensity of the proteins.

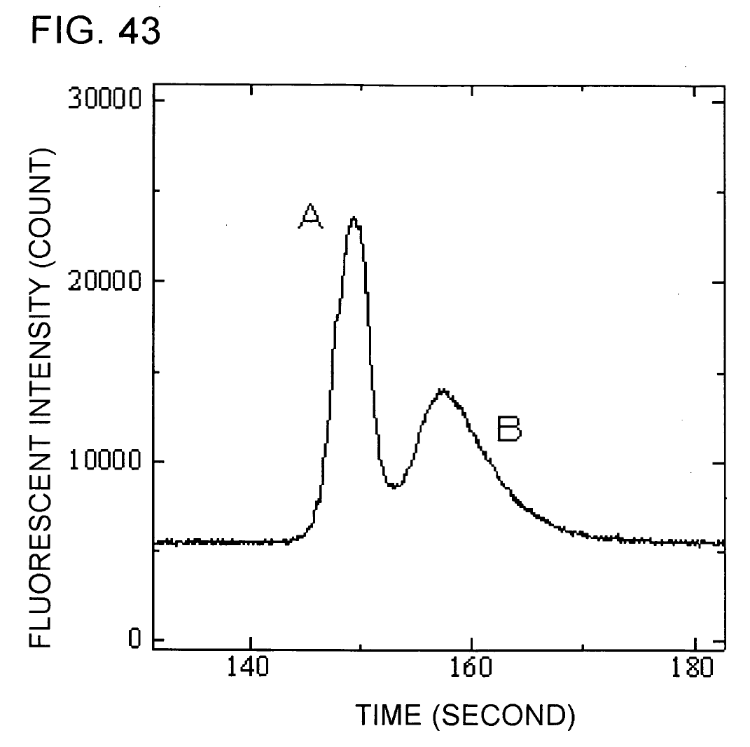

FIG. 43 is a drawing showing a separation result of the proteins. In FIG. 43, the fluorescent intensity was measured from a position 7 mm distant from the injection portion and plotted. Observation was made while varying ratio of concentration of two these species, and it was confirmed that peak A corresponds to the 97-kD protein, and peak B corresponds to the 31-kD protein. As is clear from the above, use of the separation apparatus of this Example was successful in separating, by their sizes, and detecting the denatured proteins.

As has been described in the above, the separation apparatus 100 of the Example was successful in accurately separating molecules of various sizes.

Although foregoing paragraphs have described the embodiments of the present invention, it is also allowable to arbitrarily combine the configurations respectively adopted in the embodiments.

1. A separation apparatus comprising:
a channel through which a sample flows;
a wall portion of said channel; and
a sample separation region provided to said channel;
wherein, in said sample separation region, said wall portion is provided with a capture portion capturing a specific component in said sample.

2. The separation apparatus according to claim 1, provided with a plurality of said capture portions.

3. The separation apparatus according to claim 1 or 2, wherein said capture portion is formed normal to the direction along which said channel extends, with a small width.

4. The separation apparatus according to claim 1, wherein said capture portion is formed so as to be narrowed in the opening width in a portion more distant from the center of said channel.

5. The separation apparatus according to claim 1, wherein said capture portion is a pocket portion provided to said wall portion.

6. The separation apparatus according to claim 1, comprising:
said channel being formed on the surface of a substrate, and having an opening; and
a lid covering said opening;
wherein said lid composes a part of said wall portion; and
a gap portion between said substrate and said lid composes said capture portion.

7. The separation apparatus according to claim 6, wherein said lid is provided with a pocket portion.

8. The separation apparatus according to claim 1, wherein the surface of said wall portion has a convex curved surface with respect to said capture portion.

9. The separation apparatus according to claim 1, wherein said wall portion has a concave curved surface with respect to said capture portion.

10. The separation apparatus according to claim 1, wherein said channel has, formed in the channel on the downstream side of the channel, said capture portion larger than that formed in the channel on the upstream side of the channel.

11. The separation apparatus according to claim 1, wherein said channel has, formed in the channel on the downstream side of the channel, said capture portion having an opening width wider than that of said capture portion formed in the channel on the upstream side of the channel.

12. The separation apparatus according to claim 1, wherein said channel has, formed therein on the downstream side thereof, said capture portion having a depth smaller than that of said capture portion formed therein on the upstream side thereof.

13. A separation apparatus comprising:
a channel through which a sample flows;
a wall portion of said channel; and
a sample separation region provided to said channel;
wherein, in said sample separation region, said channel is provided with a plurality of expanded portions formed so as to have an expanded width as compared with the residual portion of said sample separation region.

14. The separation apparatus according to claim 1 or 13, wherein said channel has the widened portions and narrowed portions alternately arranged along the direction of the sample flow.

15. A separation apparatus comprising:
a channel through which a sample flows; and
a sample separation region provided to said channel;
wherein, in said sample separation region, said channel further comprises:
a partition wall;
a plurality of parallel channels divided by said partition wall; and
a plurality of capture portions, capturing a specific component in said sample, formed on said partition wall beside each of said plurality of parallel channels.

16. The separation apparatus according to claim 15, wherein said partition wall has, formed in said partition wall, a plurality of communication portions allowing said plurality of parallel channels to communicate with each other.

17. The separation apparatus according to any one of claims 1, 13, or 15, wherein said sample separation region further comprises a width-wise external force imposing unit imposing an external force to said sample in the width-wise direction of said channel.

18. A separation apparatus comprising:
a plurality of channel through which a sample flows;
a plurality of sample separation regions provided to said channels; and
an external force imposing unit imposing an external force to said sample in the longitudinal direction of said channels, to thereby make said sample travel through said plurality of channels at different flow rates.

19. The separation apparatus according to any one of claims 1, 13, 15, or 18, wherein said channel is a groove formed on the substrate,
and said separation apparatus further comprises:
a sample introduction unit introducing the sample into said channel;
a sample separation region provided to said channel, separating said sample into a plurality of components; and
a sample recovery unit analyzing or fractionating said separated sample separated by said sample separation region.

20. An analytical system detecting a specific component, comprising:
the separation apparatus described in any one of claims 1, 13, 15, or 18; and
a detection unit detecting the specific component separated by said separation apparatus.

21. A method of fabricating a separation apparatus comprising a sample separation region in which a capture portion capturing a specific component of a sample is formed in a channel through which said sample flows, the method comprising:
forming on a substrate a groove which serves as said channel, and forming a plurality of pocket portions on said substrate in said groove; and
oxidizing the surface of said plurality of pocket portions so as to grow an oxide film on the surface of each of said pocket portions, to thereby form the capture portion.

22. A method of fabricating a separation apparatus comprising a sample separation region in which a capture portion capturing a specific component of a sample is formed in a channel through which said sample flows, the method comprising:
forming on a substrate a plurality of columnar structures so as to be spaced from each other; and
oxidizing the side faces of said columnar structures so as to grow an oxide film on the side faces of said columnar structures, to thereby narrow the gap between the columnar structures and to form said capture portion.

23. A method of fabricating a separation apparatus comprising a sample separation region in which a capture portion capturing a specific component of a sample is formed in a channel through which said sample flows, the method comprising:
forming a resist film on the surface of a substrate;
pressing a mold surface having an irregular profile formed thereon in contact with said resist film, to thereby transfer the irregular profile to the resist film;
removing a portion of said resist film formed in the depressed portion of said irregular profile, to thereby form resist openings; and
etching said substrate through a mask composed of said resist film having said openings formed in said resist film, to thereby form said capture portion.

24. A method of fabricating a separation apparatus comprising a sample separation region in which a capture portion capturing a specific component of a sample is formed in a channel through which said sample flows, the method comprising:
pressing a mold surface having an irregular profile formed on said mold structure in contact with a substrate composed of a resin material at least in the surficial portion of said mold structure, to thereby form said capture portion in said surficial portion.

25. A method of fabricating a separation apparatus comprising a sample separation region in which a capture portion capturing a specific component of a sample is formed in a channel through which said sample flows, the method comprising:
forming on the surface of a substrate a groove which serves as said channel, and forming a pocket portions on the surface of said groove; and
providing a cover on said substrate in said sample separation region, to thereby form said capture portion in a gap between said pocket portion and said cover.

26. The method of fabricating a separation apparatus according to any one of claims 21 to 25, forming a plurality of said capture portions.
